(19) United States
(12) Patent Application Publication
(10) Pub. No.: US 2025/0079725 A1
(43) Pub. Date: Mar. 6, 2025

(54) METHOD FOR MANUFACTURING ELECTRICAL WIRE WITH TERMINAL, TERMINAL, AND ELECTRICAL WIRE WITH TERMINAL

(71) Applicant: YAZAKI CORPORATION, Tokyo (JP)

(72) Inventor: Naoki ITO, Makinohara-shi (JP)

(21) Appl. No.: 18/805,996

(22) Filed: Aug. 15, 2024

(30) Foreign Application Priority Data
Aug. 28, 2023 (JP) 2023-138056
Feb. 7, 2024 (JP) 2024-017370

(51) Int. Cl. H01R 4/18; H01R 43/048

(52) U.S. Cl. CPC H01R 4/188; H01R 4/183; H01R 43/048

(57) ABSTRACT

There are provided a method for manufacturing an electrical wire with terminal in which a terminal is crimped to a conductor core wire of an electrical wire, the terminal, and the electrical wire with terminal. A crimped portion of the terminal has a tubular shape continuous without a slit in a circumferential direction, and has a shape before crimping in which a tubular inner face of the crimped portion includes a projecting portion protruding into a tubular portion at a cross section orthogonal to an axis of the terminal. The manufacturing method includes: inserting the conductor core wire into the tubular portion of the crimped portion; and crimping the crimped portion to the conductor core wire by caulking the crimped portion using a caulking tool, the caulking tool being configured to deform the crimped portion into the tubular portion by pressing a caulking face against the crimped portion.

### CROSS-REFERENCE TO RELATED APPLICATIONS

This application is based on and claims priority under 35 USC 119 from Japanese Patent Application No. 2023-138056 filed on Aug. 28, 2023 and Japanese Patent Application No. 2024-017370 filed on Feb. 7, 2024, the contents of which are incorporated herein by reference.

### TECHNICAL FIELD

The present disclosure relates to a method for manufacturing an electrical wire with terminal in which a terminal is crimped to a conductor core wire of an electrical wire, a terminal, and an electrical wire with terminal.

### BACKGROUND ART

The related art has proposed to manufacture an electrical wire with terminal by using a terminal including: a connected portion to be connected to a mating terminal; and a crimped portion having a tubular shape continuous without a slit in the circumferential direction (so-called closed barrel shape), and to be crimped to a conductor core wire of an electrical wire (see, for example, JP2017-224396A).

In an electrical wire with terminal of the type described above, the caulking face of the mold for caulking is generally provided with a protruding portion (so-called indent) for recessing the crimped portion into the tubular portion, thereby increasing the contact area and the contact pressure between the crimped portion of the terminal and the conductor core wire to increase the reliability of the electrical connection therebetween (for example, to reduce the contact resistance value). If the thickness of the tubular wall of the crimped portion is sufficiently small relative to the thickness of the conductor core wire, the crimped portion is easily recessed into the tubular portion after being crimped by the mold, so that the tubular inner face of the crimped portion is deformed in a manner protruding into the tubular portion. In this case, the reliability of the electrical connection between the crimped portion and the conductor core wire can be enhanced. On the other hand, if the thickness of the tubular wall of the crimped portion is large relative to the thickness of the conductor core wire, the outer face of the crimped portion may be deformed after being crimped by the mold, but the tubular inner face of the crimped portion may not be deformed in a manner protruding into the tubular portion. In this case, the contact area and the contact pressure between the crimped portion and the conductor core wire is not sufficiently, which makes it difficult to sufficiently increase the reliability of the electrical connection between the crimped portion and the conductor core wire.

### SUMMARY OF INVENTION

The present disclosure provides a method for manufacturing an electrical wire with terminal capable of improving the reliability of electrical connection between a terminal and the electrical wire, a terminal capable of improving the reliability of electrical connection between the terminal and an electrical wire, and an electrical wire with terminal having improved reliability of electrical connection between the terminal and the electrical wire.
a method for manufacturing an electrical wire with terminal, a terminal, and an electrical wire with terminal according to the present disclosure are characterized by the following features.

According to an illustrative aspect of the present disclosure, there is provided a method for manufacturing an electrical wire with terminal in which a terminal is crimped to a conductor core wire of an electrical wire. The terminal includes a connected portion to be connected to a mating terminal and a crimped portion to be crimped to the conductor core wire. The crimped portion has a tubular shape continuous without a slit in a circumferential direction, and has a shape before crimping in which a tubular inner face of the crimped portion includes a projecting portion protruding into a tubular portion at a cross section orthogonal to an axis of the terminal. The manufacturing method includes: inserting the conductor core wire into the tubular portion of the crimped portion; and crimping the crimped portion to the conductor core wire by caulking the crimped portion using a caulking tool, the caulking tool being configured to deform the crimped portion into the tubular portion by pressing a caulking face against the crimped portion.

According to another illustrative aspect of the present disclosure, a terminal to be crimped to a conductor core wire of an electrical wire, includes: a connected portion to be connected to a mating terminal; and a crimped portion to be crimped to the conductor core wire. The crimped portion has a tubular shape continuous without a slit in a circumferential direction, and has a shape before crimping in which a tubular inner face of the crimped portion includes a projecting portion protruding into the tubular portion at a cross section orthogonal to an axis of the terminal.

According to another illustrative aspect of the present disclosure, an electrical wire with terminal includes: an electrical wire; and a terminal crimped to a conductor core wire of the electrical wire. The terminal includes: a connected portion to be connected to a mating terminal; and a crimped portion crimped to the conductor core wire. The crimped portion has a tubular shape continuous without a slit in a circumferential direction, and has a shape in which a tubular inner face of the crimped portion has a plurality of curved faces convex out of a tubular portion at a cross section orthogonal to an axis of the terminal. At the cross section, a location where one of the curved faces and another of the curved faces are coupled defines a projecting portion protruding into the tubular portion of the crimped portion.

According to the method for manufacturing an electrical wire with terminal, the terminal, and the electrical wire with terminal of the present disclosure, the crimped portion of the terminal has a tubular shape continuous without a slit in the circumferential direction (so-called closed barrel shape), and has, at a cross section orthogonal to the axis of the terminal, a shape before crimping in which the tubular inner face of the crimped portion has a projecting portion protruding into the tubular portion. Accordingly, when the crimped portion is deformed into the tubular portion using the caulking tool, the crimped portion is crimped to the conductor core wire in a shape in which the projecting portion of the tubular inner face of the crimped portion bites into the conductor core wire. Further, the projecting portion of the tubular inner face of the crimped portion is strongly pressed against the conductor core wire. Accordingly, the contact area and the contact pressure between the crimped portion and the conductor core wire increase as compared with a case without a projecting portion on the tubular inner face of the crimped portion. This increases the reliability of the electrical connection between the crimped portion and the conductor core wire. Therefore, according to the manufacturing method and the terminal of the present disclosure, it is possible to manufacture an electrical wire with terminal that can improve the reliability of the electrical connection between the terminal and the electrical wire. According to the electrical wire with terminal of the present disclosure, it is possible to improve the reliability of the electrical connection between the terminal and the electrical wire.

The present disclosure has been briefly described above. Details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a side view illustrating a state in which an electrical wire and a terminal that are included in an electrical wire with terminal according to a first embodiment of the present disclosure are separated from each other.

FIG. 2 is a side view illustrating a state in which a conductor core wire of the electrical wire illustrated in FIG. 1 is inserted into a tubular portion of a crimped portion of the terminal illustrated in FIG. 1.

FIG. 3 is a cross-sectional view taken along a line A-A in FIG. 2.

FIG. 4 illustrates a step of caulking the crimped portion of the terminal illustrated in FIG. 2 with a mold and crimping the crimped portion to the conductor core wire.

FIG. 5 is a cross-sectional view after crimping corresponding to FIG. 3.

FIG. 6 is a side view of the electrical wire with terminal according to the first embodiment of the present disclosure, which is completed by crimping.

FIG. 7 is a cross-sectional view corresponding to FIG. 3 of an electrical wire with terminal according to a second embodiment.

FIG. 8 is a cross-sectional view corresponding to FIG. 5 of an electrical wire with terminal according to a second embodiment.

FIG. 9 is a cross-sectional view corresponding to FIG. 3 of an electrical wire with terminal according to a third embodiment.

FIG. 10 is a cross-sectional view corresponding to FIG. 5 of an electrical wire with terminal according to a third embodiment.

FIG. 11 is a cross-sectional view corresponding to FIG. 3 of an electrical wire with terminal according to a fourth embodiment.

FIG. 12 is a cross-sectional view corresponding to FIG. 5 of an electrical wire with terminal according to a fourth embodiment.

FIG. 13 is a side view of a terminal that is included in an electrical wire with terminal according to a fifth embodiment.

FIG. 14A is a cross-sectional view taken along a line B-B of FIG. 13.

FIG. 14B is a cross-sectional view taken along a line C-C of FIG. 13.

FIG. 14C is a cross-sectional view taken along a line D-D of FIG. 13.

FIG. 15A is a cross-sectional view after crimping corresponding to FIG. 14A.

FIG. 15B is a cross-sectional view after crimping corresponding to FIG. 14B.

FIG. 15C is a cross-sectional view after crimping corresponding to FIG. 14C.

FIG. 16 is a side view of a terminal that is included in an electrical wire with terminal according to a sixth embodiment.

FIG. 17A is a cross-sectional view taken along a line E-E of FIG. 16.

FIG. 17B is a cross-sectional view taken along a line F-F of FIG. 16.

FIG. 17C is a cross-sectional view taken along a line G-G of FIG. 16.

FIG. 18A is a cross-sectional view after crimping corresponding to FIG. 17A.

FIG. 18B is a cross-sectional view after crimping corresponding to FIG. 17B.

FIG. 18C is a cross-sectional view after crimping corresponding to FIG. 17C.

FIG. 19 is a side view of a terminal that is included in an electrical wire with terminal according to a seventh embodiment.

FIG. 20A is a cross-sectional view taken along a line H-H of FIG. 19.

FIG. 20B is a cross-sectional view taken along a line I-I of FIG. 19.

FIG. 20C is a cross-sectional view taken along a line J-J of FIG. 19.

FIG. 21A is a cross-sectional view after crimping corresponding to FIG. 20A.

FIG. 21B is a cross-sectional view after crimping corresponding to FIG. 20B.

FIG. 21C is a cross-sectional view after crimping corresponding to FIG. 20C.

FIG. 22 is a side view of a terminal that is included in an electrical wire with terminal according to an eighth embodiment.

FIG. 23A is a cross-sectional view taken along a line K-K of FIG. 22.

FIG. 23B is a cross-sectional view taken along a line L-L of FIG. 22.

FIG. 23C is a cross-sectional view taken along a line M-M of FIG. 22.

FIG. 24A is a cross-sectional view after crimping corresponding to FIG. 23A.

FIG. 24B is a cross-sectional view after crimping corresponding to FIG. 23B.

FIG. 24C is a cross-sectional view after crimping corresponding to FIG. 23C.

### DESCRIPTION OF EMBODIMENTS

### First Embodiment

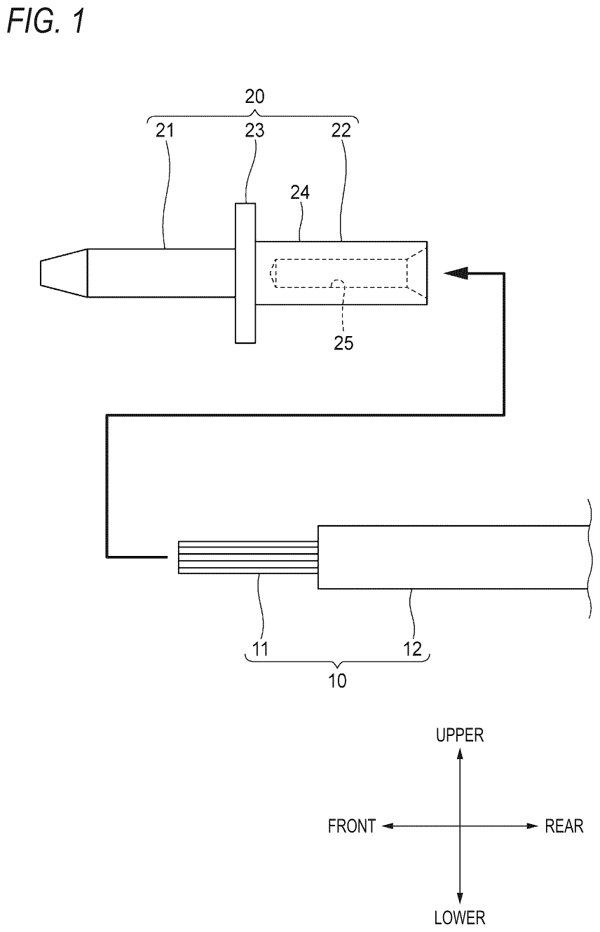

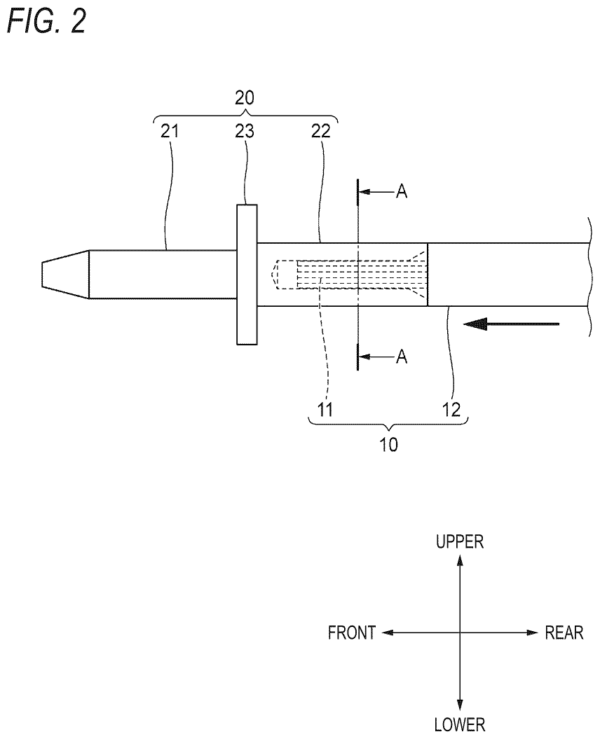

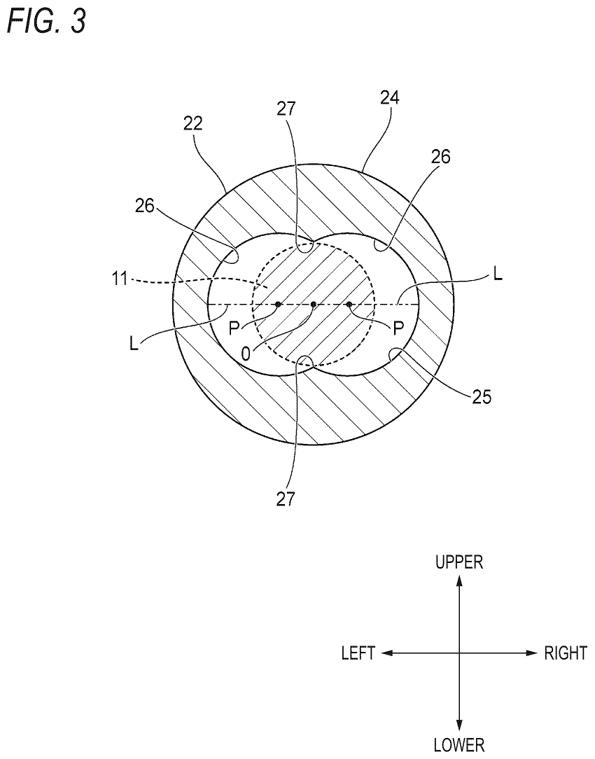

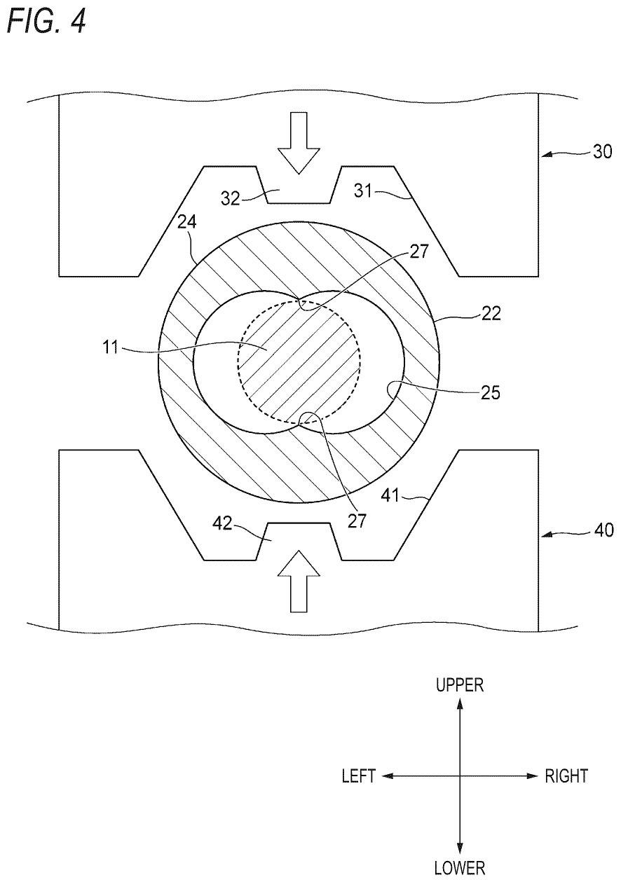

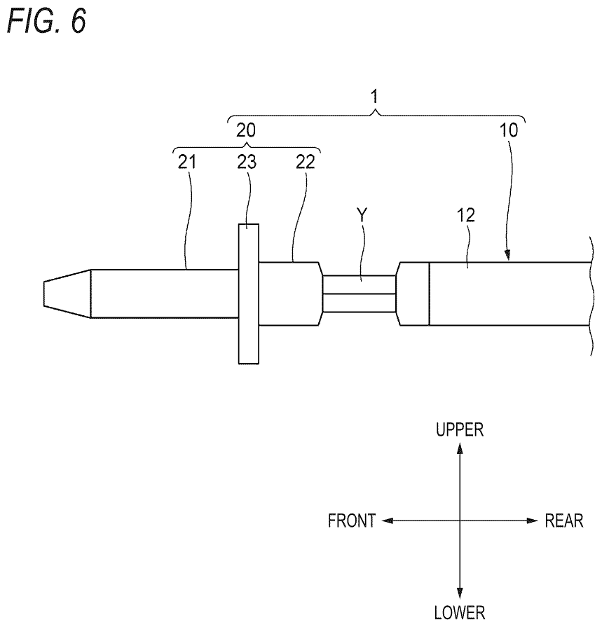

Hereinafter, a method for manufacturing an electrical wire with terminal 1 (see FIG. 6) according to a first embodiment of the present disclosure will be described with reference to the drawings. As illustrated in FIG. 1, the electrical wire with terminal 1 illustrated in FIG. 6 includes an electrical wire 10 and a male terminal 20. The electrical wire with terminal 1 illustrated in FIG. 6 is manufactured by caulking a crimped portion 22 of the terminal 20 (see FIGS. 2 and 3), which is inserted with a conductor core wire 11 of the electrical wire 10, with a pair of upper and lower molds 30, 40 illustrated in FIG. 4 and crimping the crimped portion 22 to the conductor core wire 11. This example uses a male terminal 20, but may alternatively use a female terminal 20.

Hereinafter, for convenience of description, as illustrated in FIG. 1, a “front-rear direction”, an “upper-lower direction”, and a “left-right direction” are defined. The “front-rear direction”, the “upper-lower direction”, and the “left-right direction” are orthogonal to one another. The front-rear direction coincides with the axial direction of the terminal 20. The radial direction and circumferential direction of the terminal 20 (crimped portion 22) are simply referred to as “radial direction” and “circumferential direction”. Hereinafter, the components that are included in the electrical wire with terminal 1 will be first described in order.

First, the electrical wire 10 will be described. As illustrated in FIG. 1, the electrical wire 10 includes a rod-shaped (elongated columnar) metallic conductor core wire 11, and a cylindrical-shaped resin insulating sheath 12 that covers the outer periphery of the conductor core wire 11. The conductor core wire 11 may be formed by bundling a plurality of conductor wires or may be formed from only one elongated columnar conductor. At the distal end (front end) of the electrical wire 10, the insulating sheath 12 is removed by so-called terminal processing to expose the conductor core wire 11 by a predetermined length.

Next, the terminal 20 will be described. The metallic terminal 20 is formed by casting, cutting, or the like. As illustrated in FIG. 1, the terminal 20 is a male terminal, and includes a connected portion 21 positioned closer to the distal end (front end) and a crimped portion 22 positioned closer to the base end (rear end). The connected portion 21 is a portion to be inserted into the base end side of a female mating terminal (not illustrated) and connected to the mating terminal, and has a solid columnar shape extending in the front-rear direction. The distal end (front end) of the connected portion 21 has a shape in which the diameter decreases as approaching the distal end (so-called tapered shape), so that the connected portion 21 can be easily inserted into the mating terminal.

The crimped portion 22 is a portion to be inserted with the exposed conductor core wire 11 of the electrical wire 10 from the rear side and crimped to the conductor core wire 11, and has, before crimping, a generally hollow cylindrical shape extending in the front-rear direction and having a closed front end and an open rear end (see FIGS. 1 and 3). In other words, the crimped portion 22 has a tubular shape continuous without a slit in the circumferential direction (so-called closed barrel shape). The base end (rear end) of the tubular inner face 25 of the crimped portion 22 has a shape in which the diameter increases as approaching the base end (so-called flared shape), so that the conductor core wire 11 of the electrical wire 10 can be easily inserted into the crimped portion 22.

Hereinafter, a cross section orthogonal to the front-rear direction of the crimped portion 22 (a cross section orthogonal to the axis of the terminal 20) is simply referred to as a “cross section”. Before crimping, the outer face 24 of the crimped portion 22 (see FIG. 1) has a simple shape of a cylindrical outer periphery face, and the cross section of the outer face 24 is circular (see FIG. 3). On the other hand, before crimping, the tubular inner face 25 of the crimped portion 22 has a shape including projecting portions 27, which are protruding strips that protrude radially inward (into the tubular portion) and extends in the front-rear direction, except for the base end described above. More specifically, as illustrated in FIG. 3, the tubular inner face 25 of the crimped portion 22 has, at the cross section, a shape in which two circular shapes 26 are combined while partially overlapping each other, the overlapping locations of the two circular shapes 26 (two locations) respectively having the projecting portions 27. The two circular shapes 26 have the same radius. The centers p of the two circular shapes 26 are respectively located at positions separated by the same distance from the center O on two line segments L extending radially outward from the center O of the circular outer face 24 and bisecting the circumferential direction.

The tubular inner face 25 of the crimped portion 22 has the same shape over the entire axial direction of the terminal 20 (front-rear direction), except for the base end described above. The tubular inner face 25 of the crimped portion 22 may be formed by, for example, cutting with a drill. Specifically, the tubular inner face 25 can be formed by arranging a drill whose outer diameter is equal to or smaller than the diameter of the circular shapes 26 such that the axis thereof is parallel to the axial direction of the terminal 20, and inserting the drill into the crimped portion 22 before the tubular inner face 25 is formed (solid) from the rear to perform cutting. If using a drill whose outer diameter is equal to the diameter of the circular shapes 26, the tubular inner face 25 of the crimped portion 22 can be formed by simply inserting the drill twice, corresponding to the two circular shapes 26, into the crimped portion 22 before the tubular inner face 25 is formed.

As illustrated in FIG. 1, the boundary between the connected portion 21 and the crimped portion 22 is provided with an annular and flat plate-shaped flange 23 extending radially outward over the entire region in the circumferential direction. The components that are included in the electrical wire with terminal 1 have been described in order.

Next, the pair of upper and lower molds 30, 40 used when caulking the crimped portion 22 of the terminal 20 inserted with the conductor core wire 11 of the electrical wire 10 will be described with reference to FIG. 4. The pair of upper and lower molds 30, 40 are configured such that the entire caulking faces have a hexagonal cross-sectional shape when clamped. Therefore, a caulking face 31 of the upper mold 30 has a cross-sectional shape of the upper half of the hexagonal shape, and a caulking face 41 of the lower mold 40 has a cross-sectional shape of the lower half of the hexagonal shape. Further, the central portion in the left-right direction of the caulking face 31 of the upper mold 30 is provided with a protruding portion 32 (so-called indent), which is a protruding strip that protrudes downward (that is, into the tubular portion of the crimped portion 22) and extends in the front-rear direction, thereby recessing the crimped portion 22 into the tubular portion of the crimped portion 22. Similarly, the central portion in the left-right direction of the caulking face 41 of the lower mold 40 is provided with a protruding portion 42, which is a protruding strip that protrudes upward (that is, into the tubular portion of the crimped portion 22) and extends in the front-rear direction, thereby recessing the crimped portion 22 into the tubular portion of the crimped portion 22. The pair of upper and lower protruding portions 32, 42 face each other in the upper-lower direction.

Next, a method for manufacturing the electrical wire with terminal 1 illustrated in FIG. 6 will be described. In order to manufacture the electrical wire with terminal 1, first, the exposed conductor core wire 11 of the electrical wire 10 is inserted into the crimped portion 22 of the terminal 20 from the rear side (see FIGS. 1 and 2). When the insertion is completed, the conductor core wire 11 of the exposed electrical wire 10 is accommodated in the tubular portion of the crimped portion 22. The conductor core wire 11 is only required to be inserted to a position suitable for crimping (details will be described later) in the tubular portion of the crimped portion 22. The distal face (front end face) of the insulating sheath 12 of the electrical wire 10 may be in contact with the base end face (rear end face) of the crimped portion 22, or the distal face (front end face) of the insulating sheath 12 of the electrical wire 10 may be separated from the base end face (rear end face) of the crimped portion 22.

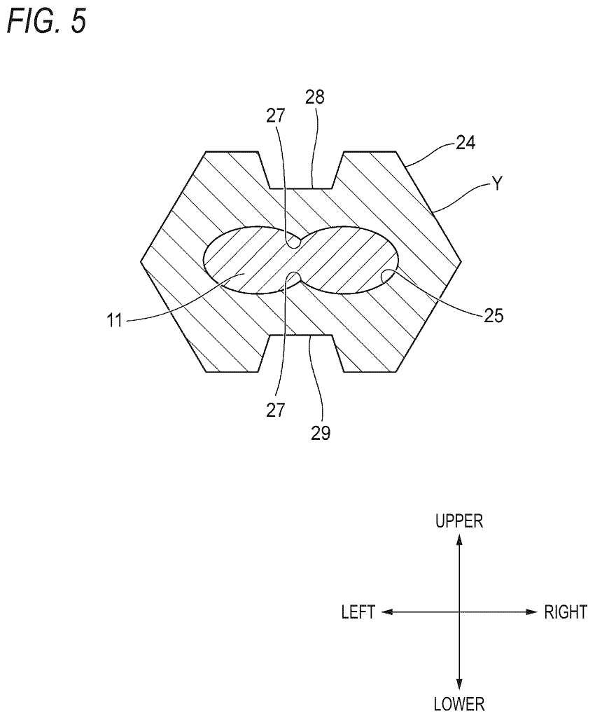

Next, as illustrated in FIG. 4, the upper mold 30 and the lower mold 40 are respectively arranged above and below the crimped portion 22 of the terminal 20 inserted with the conductor core wire 11 of the electrical wire 10. Next, the pair of upper and lower molds 30, 40 relatively approach each other in the upper-lower direction, so that the crimped portion 22 is sandwiched in the upper-lower direction between the pair of upper and lower molds 30, 40. Thereby, the caulking face 31 including the protruding portion 32 of the mold 30 and the caulking face 41 including the protruding portion 42 of the mold 40 are pressed against the crimped portion 22. Accordingly, as illustrated in FIG. 5, the crimped portion 22 is deformed into the tubular portion and caulked, so that the crimped portion 22 is crimped to the conductor core wire 11 of the electrical wire 10. Thus, as illustrated in FIG. 6, the electrical wire with terminal 1 formed with the caulking location Y in a part of the crimped portion 22 in the front-rear direction is manufactured.

As illustrated in FIG. 5, the outer face 24 of the crimped portion 22 after crimping has a hexagonal cross-sectional shape that corresponds to the cross-sectional shape formed by the caulking faces 31, 41 of the molds 30, 40. Further, the locations on the outer face 24 after the crimping that correspond to the protruding portions 32, 42 on the caulking faces 31, 41 are bitten in by the protruding portions 32, 42, thereby forming recesses 28, 29. The tubular inner face 25 of the crimped portion 22 after crimping has a cross-sectional shape compressed in the upper-lower direction as compared with the tubular inner face 25 before crimping. More specifically, after crimping, the crimped portion 22 has a tubular shape continuous without a slit in the circumferential direction, and has, at the cross section illustrated in FIG. 5, a shape in which the tubular inner face 25 of the crimped portion 22 has a plurality of curved faces convex out of the tubular portion. A location at which one of the curved faces and another of the curved faces are coupled defines a projecting portion 27 protruding into the tubular portion of the crimped portion 22. Further, the projecting portions 27 of the tubular inner face 25 (two locations) bite into the conductor core wire 11 of the electrical wire 10. Accordingly, the projecting portions 27 of the crimped portion 22 (two locations) are strongly pressed against the conductor core wire 11. Thus, even if the thickness of the tubular wall of the crimped portion 22 is relatively large, the contact area and the contact pressure between the crimped portion 22 and the conductor core wire 11 increase as compared with the case where the tubular inner face 25 of the crimped portion 22 is not provided with the projecting portions 27. Further, the crimped portion 22 is recessed into the tubular portion due to the biting of the protruding portions 32, 42 (due to the outer face 24 being formed with the recessed portions 28, 29), so that the crimped portion 22 is crimped to the conductor core wire 11 in a shape in which the projecting portions 27 of the tubular inner face 25 bite more deeply into the conductor core wire 11 of the electrical wire 10, and the projecting portions 27 of the tubular inner face 25 are more strongly pressed against the conductor core wire 11.

### Second Embodiment

In the first embodiment, in order for the tubular inner face 25 of the crimped portion 22 to have a shape having the projecting portions 27, as illustrated in FIG. 3, the tubular inner face 25 has, at the cross section, a shape in which two circular shapes 26 are combined while partially overlapping with each other, the overlapping locations of the two circular shapes 26 (two locations) respectively having the projecting portions 27.

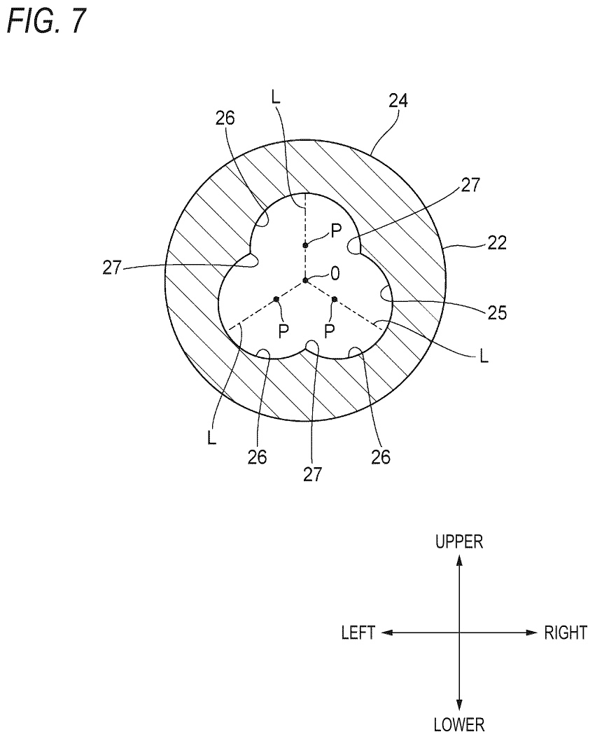

On the other hand, in the second embodiment, in order for the tubular inner face 25 of the crimped portion 22 to have a shape having the projecting portions 27, as illustrated in FIG. 7, the tubular inner face 25 may have, at the cross section, a shape in which three circular shapes 26 are combined such that each two circular shapes 26 adjacent in the circumferential direction partially overlap each other, the overlapping locations of the three circular shapes 26 (three locations) respectively having the projecting portions 27. In this case, the three circular shapes 26 have the same radius. The centers p of the three circular shapes 26 are respectively located at positions separated by the same distance from the center O on three line segments L extending radially outward from the center O of the circular outer face 24 and trisecting the circumferential direction.

Also in the second embodiment, the tubular inner face 25 of the crimped portion 22 has the same shape over the entire axial direction of the terminal 20 (front-rear direction), except for the base end described above. The tubular inner face 25 of the crimped portion 22 can be formed by, for example, arranging a drill whose outer diameter is equal to or smaller than the diameter of the circular shapes 26 such that the axis thereof is parallel to the axial direction of the terminal 20, and inserting the drill into the crimped portion 22 before the tubular inner face 25 is formed (solid) from the rear to perform cutting. If using a drill whose outer diameter is equal to the diameter of the circular shapes 26, the tubular inner face 25 of the crimped portion 22 can be formed by simply inserting the drill three times, corresponding to the three circular shapes 26, into the crimped portion 22 before the tubular inner face 25 is formed.

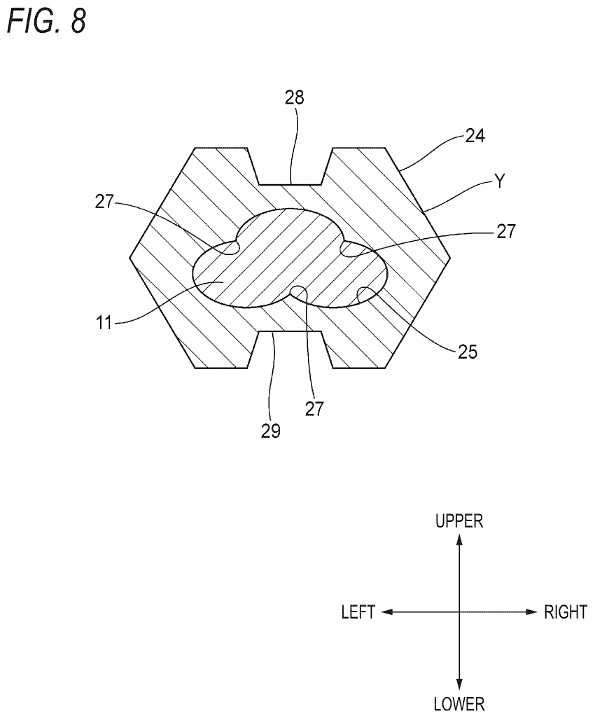

Also in this case, after crimping using the pair of upper and lower molds 30, 40 illustrated in FIG. 4, the projecting portions 27 of the tubular inner face 25 (three locations) bite into the conductor core wire 11 of the electrical wire 10, as illustrated in FIG. 8. Accordingly, the projecting portions 27 of the crimped portion 22 (three locations) are strongly pressed against the conductor core wire 11.

### Third Embodiment

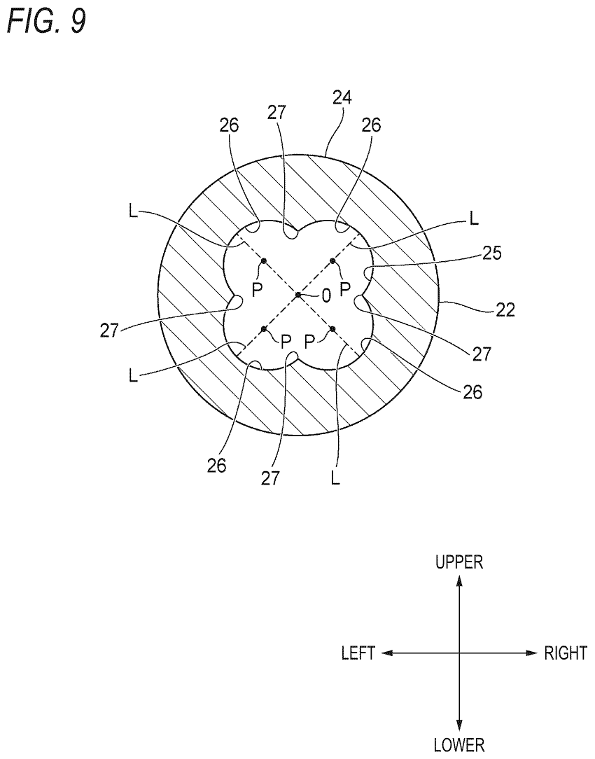

Similarly, in the third embodiment, in order for the tubular inner face 25 of the crimped portion 22 to have a shape having the projecting portions 27, as illustrated in FIG. 9, the tubular inner face 25 may have, at the cross section, a shape in which four circular shapes 26 are combined such that each two circular shapes 26 adjacent in the circumferential direction partially overlap each other, the overlapping locations of the four circular shapes 26 (four locations) respectively constituting the projecting portions 27. In this case, the four circular shapes 26 have the same radius. The centers p of the four circular shapes 26 are respectively located at positions separated by the same distance from the center O on four line segments L extending radially outward from the center O of the circular outer face 24 and dividing the circumferential direction into four equal parts.

Also in the third embodiment, the tubular inner face 25 of the crimped portion 22 has the same shape over the entire axial direction of the terminal 20 (front-rear direction), except for the base end described above. The tubular inner face 25 of the crimped portion 22 can be formed by, for example, arranging a drill whose outer diameter is equal to or smaller than the diameter of the circular shapes 26 such that the axis thereof is parallel to the axial direction of the terminal 20, and inserting the drill into the crimped portion 22 before the tubular inner face 25 is formed (solid) from the rear to perform cutting. If using a drill whose outer diameter is equal to the diameter of the circular shapes 26, the tubular inner face 25 of the crimped portion 22 can be formed by simply inserting the drill four times, corresponding to the four circular shapes 26, into the crimped portion 22 before the tubular inner face 25 is formed.

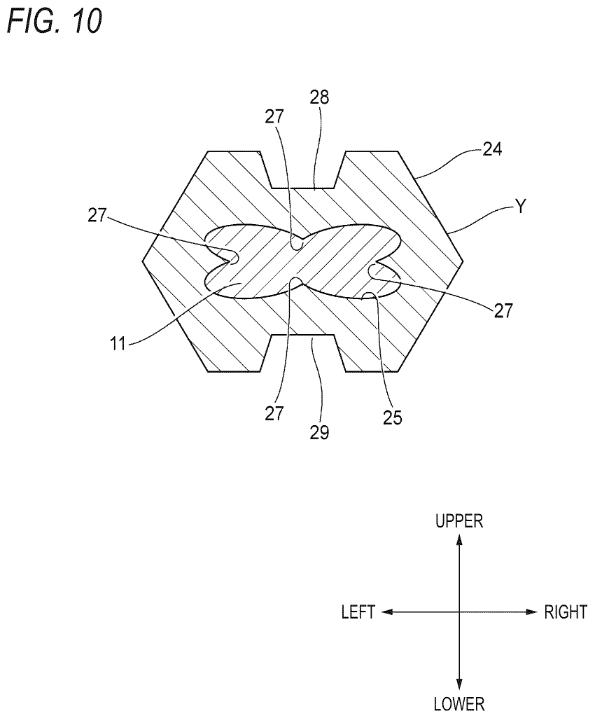

Also in this case, after crimping using the pair of upper and lower molds 30, 40 illustrated in FIG. 4, the projecting portions 27 of the tubular inner face 25 (four locations) bite into the conductor core wire 11 of the electrical wire 10, as illustrated in FIG. 10. Accordingly, the projecting portions 27 of the crimped portion 22 (four locations) are strongly pressed against the conductor core wire 11.

### Fourth Embodiment

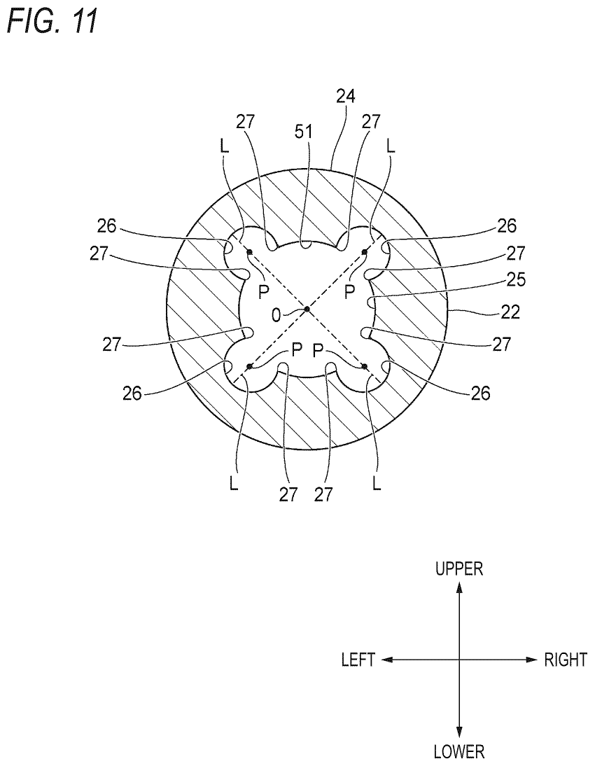

Similarly, in the fourth embodiment, in order for the tubular inner face 25 of the crimped portion 22 to have shape having the projecting portions 27, as illustrated in FIG. 11, the tubular inner face 25 may have, at the cross section, a shape in which one large circular shape 51 centered on the center O of the outer face 24 and four small circular shapes 26 arranged at intervals along the circumferential direction on the periphery of the large circular shape 51 are combined such that the one large circular shape 51 and the four small circular shapes 26 partially overlap each other, the overlapping locations of the large circular shape 51 and the four small circular shapes 26 (eight locations) respectively having the projecting portions 27. In this case, the four circular shapes 26 have the same radius. The centers p of the four circular shapes 26 are respectively located at positions separated by the same distance from the center O on four line segments L extending radially outward from the center O of the circular outer face 24 and dividing the circumferential direction into four equal parts.

Also in the fourth embodiment, the tubular inner face 25 of the crimped portion 22 has the same shape over the entire axial direction of the terminal 20 (front-rear direction), except for the base end described above. The tubular inner face 25 of the crimped portion 22 can be formed by, for example, arranging a drill whose outer diameter is equal to or smaller than the diameter of the circular shapes 26 such that the axis thereof is parallel to the axial direction of the terminal 20, and inserting the drill into the crimped portion 22 before the tubular inner face 25 is formed (solid) from the rear to perform cutting. If using a first drill whose outer diameter is equal to the diameter of the circular shape 51 and a second drill whose outer diameter is equal to the diameter of the circular shapes 26, the tubular inner face 25 of the crimped portion 22 can be formed by simply inserting the first drill once, corresponding to the one circular shape 51, and inserting the second drill four times, corresponding to the four circular shapes 26, into the crimped portion 22 before the tubular inner face 25 is formed.

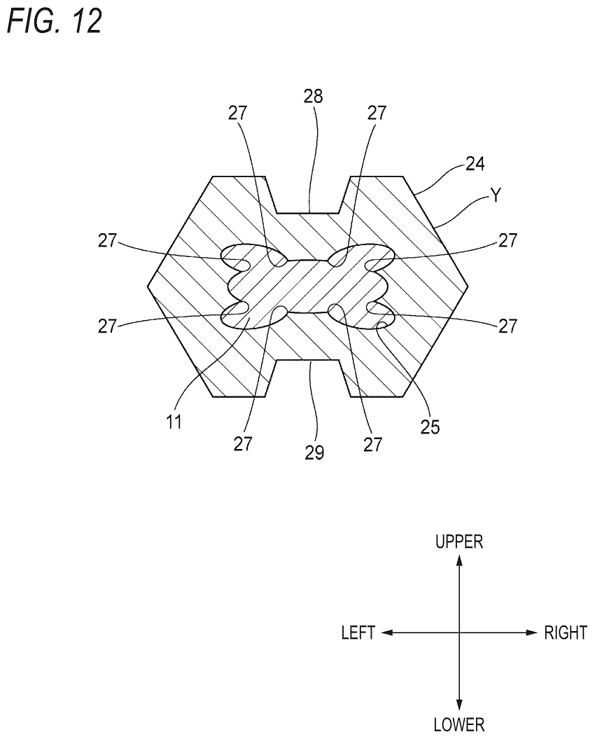

Also in this case, after crimping using the pair of upper and lower molds 30, 40 illustrated in FIG. 4, the projecting portions 27 of the tubular inner face 25 (eight locations) bite into the conductor core wire 11 of the electrical wire 10, as illustrated in FIG. 12. Accordingly, the projecting portions 27 of the crimped portion 22 (eight locations) are strongly pressed against the conductor core wire 11.

### Fifth Embodiment

In the first embodiment, as illustrated in FIG. 3, in the tubular inner face 25 of the crimped portion 22 of the terminal 20, the overlapping locations of the two circular shapes 26 (two locations) respectively have the projecting portions 27, and the tubular inner face 25 of the crimped portion 22 has the same shape over the entire axial direction of the terminal 20 (front-rear direction), except for the base end described above. In other words, the distance between the center O and the center p of each of the two circular shapes 26 at the cross section of the tubular inner face 25 of the crimped portion 22 is constant regardless of the position in the axial direction of the terminal 20 (front-rear direction), except for the base end described above.

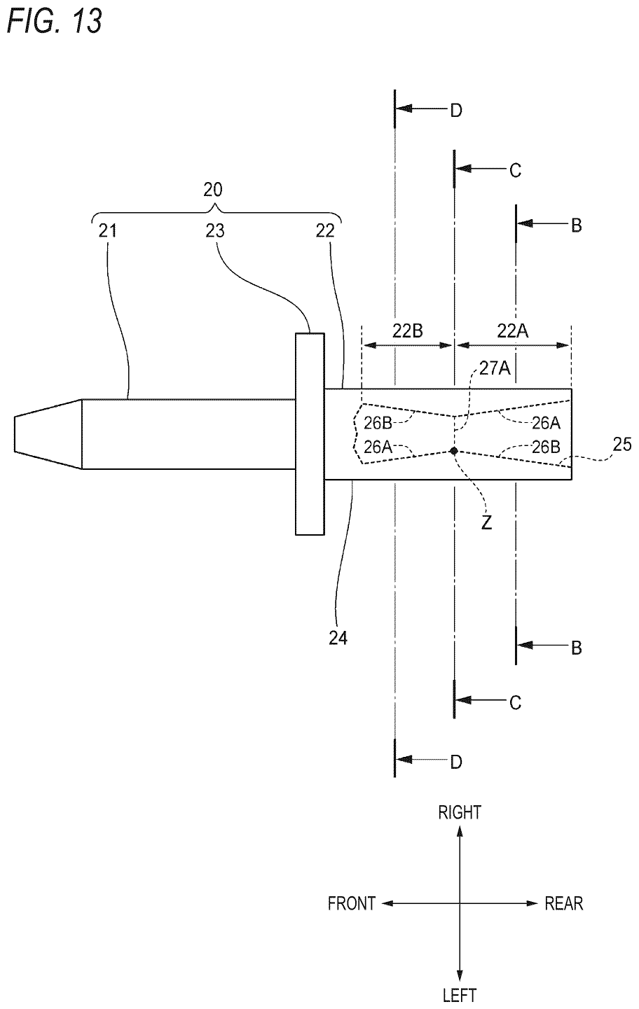

On the other hand, the fifth embodiment illustrated in FIGS. 13 to 15C is the same as the first embodiment in that the overlapping locations of the two circular shapes 26 (two locations) on the tubular inner face 25 of the crimped portion 22 respectively have the projecting portions 27, and is different from the first embodiment in that the distance between the center O and the center p of each of the two circular shapes 26 at the cross section of the tubular inner face 25 of the crimped portion 22 changes depending on the position in the axial direction of the terminal 20 (front-rear direction).

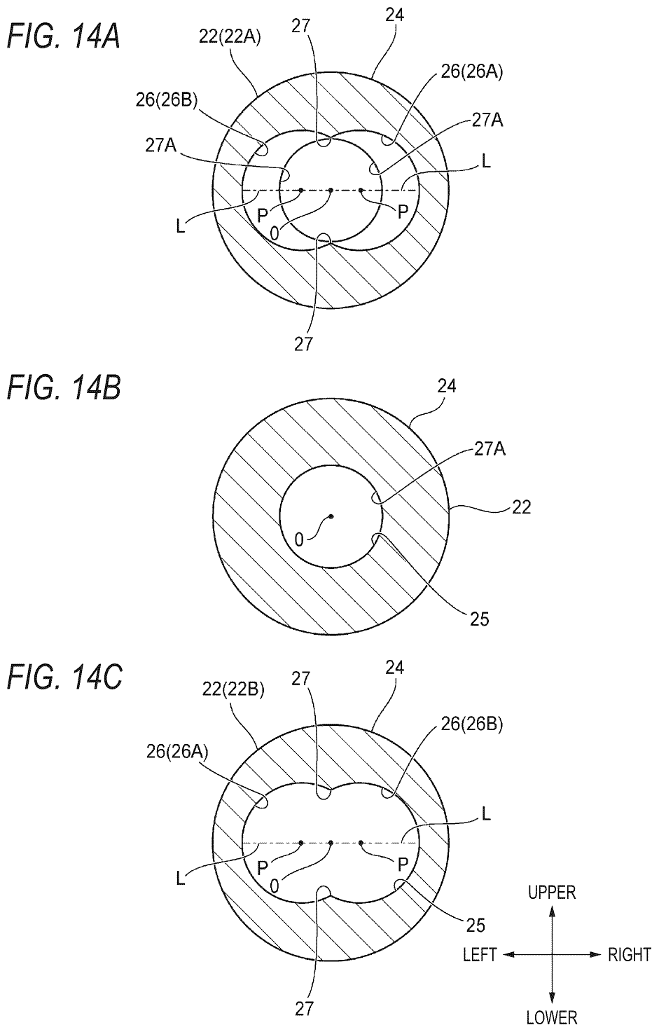

Specifically, in the fifth embodiment, as illustrated in FIG. 13, the crimped portion 22 of the terminal 20 includes a base part 22A, and a distal part 22B aligned with the base part 22A in the axial direction of the terminal 20 and continuous with the distal end side (front side) of the base part 22A. The tubular inner space of the base part 22A and the tubular inner space of the distal part 22B are adjacent and communicate with each other at a boundary position z (see FIG. 13) between the base part 22A and the distal part 22B. As can be understood from comparison between FIG. 14A and FIG. 14C, the positions of the projecting portions 27 on the tubular inner face 25 of the base part 22A (two locations) and the positions of the projecting portions 27 on the tubular inner face 25 of the distal part 22B (two locations) coincide with each other in the circumferential direction (the direction around the axis of the terminal 20).

In the base part 22A, as illustrated in FIG. 13 and FIG. 14A, the distance between the center O and the center p of each of the two circular shapes 26 at the cross section of the tubular inner face 25 of the crimped portion 22 linearly increases from zero as the position in the axial direction of the terminal 20 (front-rear direction) approaches the base end side (rear end side) from the boundary position z. In the distal part 22B, as illustrated in FIG. 13 and FIG. 14C, the distance between the center O and the center p of each of the two circular shapes 26 at the cross section of the tubular inner face 25 of the crimped portion 22 gradually increases from zero as the position in the axial direction of the terminal 20 (front-rear direction) approaches the distal end side (front end side) from the boundary position z. In other words, the base part 22A has a shape in which the cross-sectional area of the tubular inner space decreases as approaching the distal part 22B, and the distal part 22B has a shape in which the cross-sectional area of the tubular inner space decreases as approaching the base part 22A. The tubular inner space of the base part 22A and the tubular inner space of the distal part 22B are adjacent and communicate with each other. As a result, as illustrated in FIG. 13, the tubular inner space is locally narrowed at the boundary position z, and the tubular inner face 25 at the boundary position z has a shape having projecting portions 27A, which are protruding strips that protrude radially inward (into the tubular portion) and extend over the entire circumference in the circumferential direction (the direction around the axis of the terminal 20).

The tubular inner face 25 of the crimped portion 22 can be formed by, for example, arranging a drill whose outer diameter is equal to or smaller than the diameter of the circular shapes 26 such that the axis thereof is inclined relative to the axial direction of the terminal 20, and inserting the drill into the crimped portion 22 before the tubular inner face 25 is formed (solid) from the rear to perform cutting.

Specifically, the formation can be performed by, at locations on the tubular inner face 25 corresponding to circular shapes 26A at a cross section of the base part 22A (see FIG. 14A) and circular shapes 26A at a cross section of the distal part 22B (see FIG. 14C), arranging a drill whose outer diameter is equal to or smaller than the diameter of the circular shapes 26 such that the axis thereof is inclined rightward on the base end side (rear end side) and inclined leftward on the distal end side (front end side) relative to the axial direction of the terminal 20, and inserting the drill into the crimped portion 22 from the rear side to perform cutting. Further, the formation can be performed by, at locations corresponding to circular shapes 26B at a cross section of the base part 22A (see FIG. 14A) and circular shapes 26B at a cross section of the distal part 22B (see FIG. 14C), arranging a drill whose outer diameter is equal to or smaller than the diameter of the circular shapes 26 such that the axis thereof is inclined leftward on the base end side (rear end side) and inclined rightward on the distal end side (front end side) relative to the axial direction of the terminal 20, and inserting the drill into the crimped portion 22 from the rear side to perform cutting. If using a drill whose outer diameter is equal to the diameter of the circular shapes 26, the tubular inner face 25 of the crimped portion 22 (that means combination of the part 22A and the distal part 22B) can be formed by simply inserting the drill twice, corresponding to the two circular shapes 26, into the crimped portion 22.

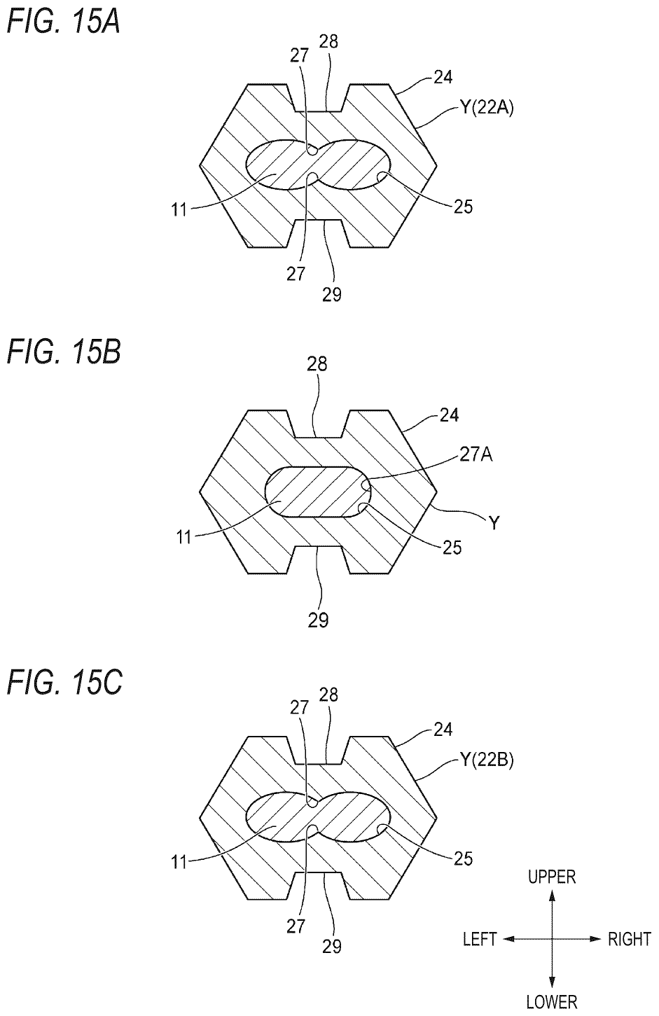

Also in the fifth embodiment, after crimping using the pair of upper and lower molds 30, 40 illustrated in FIG. 4, the projecting portions 27 of the tubular inner face 25 (two locations) bite into the conductor core wire 11 of the electrical wire 10 in both the base part 22A and the distal part 22B, as illustrated in FIGS. 15A to 15C. Accordingly, the projecting portions 27 of the crimped portion 22 (two locations) are strongly pressed against the conductor core wire 11. Further, at the boundary position z between the base part 22A and the distal part 22B, the projecting portions 27A of the tubular inner face 25 (see FIG. 13) also bite into the conductor core wire 11 of the electrical wire 10. Further, the tubular inner face 25 is inclined relative to the conductor core wire 11, thereby increasing the contact area between the tubular inner face 25 and the conductor core wire 11. This further increases the reliability of the electrical connection between the crimped portion 22 and the conductor core wire 11.

### Sixth Embodiment

In the second embodiment, as illustrated in FIG. 7, in the tubular inner face 25 of the crimped portion 22 of the terminal 20, the overlapping locations of the three circular shapes 26 (three locations) respectively have the projecting portions 27, and the tubular inner face 25 of the crimped portion 22 has the same shape over the entire axial direction of the terminal 20 (front-rear direction), except for the base end described above. In other words, the distance between the center O and the center p of each of the three circular shapes 26 at the cross section of the tubular inner face 25 of the crimped portion 22 is constant regardless of the position in the axial direction of the terminal 20 (front-rear direction) except for the base end described above.

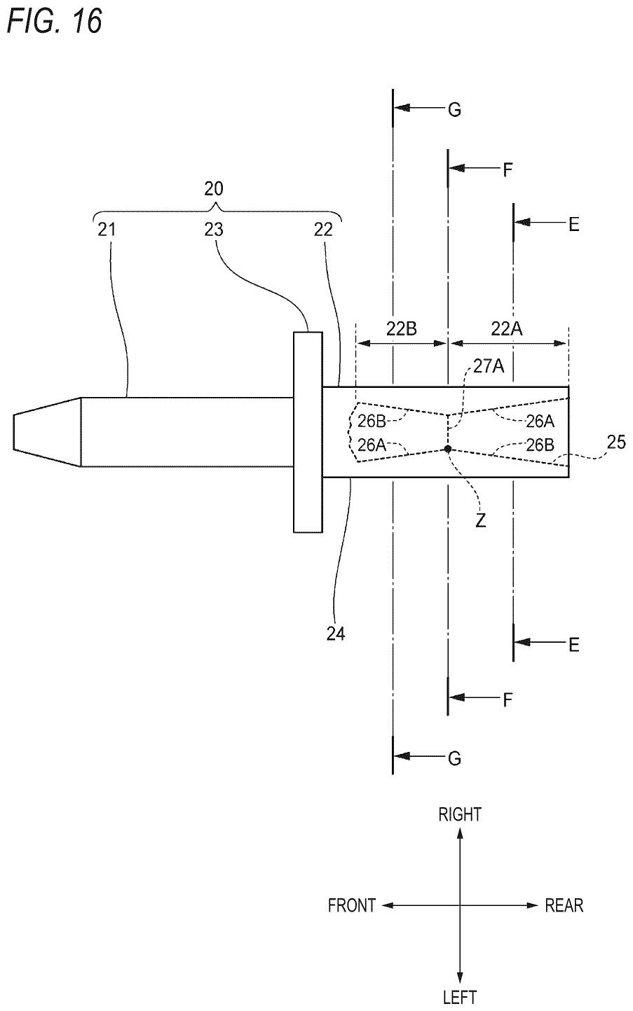

On the other hand, the sixth embodiment illustrated in FIGS. 16 to 18C is the same as the second embodiment in that the overlapping locations of the three circular shapes 26 (three locations) on the tubular inner face 25 of the crimped portion 22 respectively have the projecting portions 27, and is different from the second embodiment in that the distance between the center O and the center p of each of the three circular shapes 26 at the cross section of the tubular inner face 25 of the crimped portion 22 changes depending on the position in the axial direction of the terminal 20 (front-rear direction).

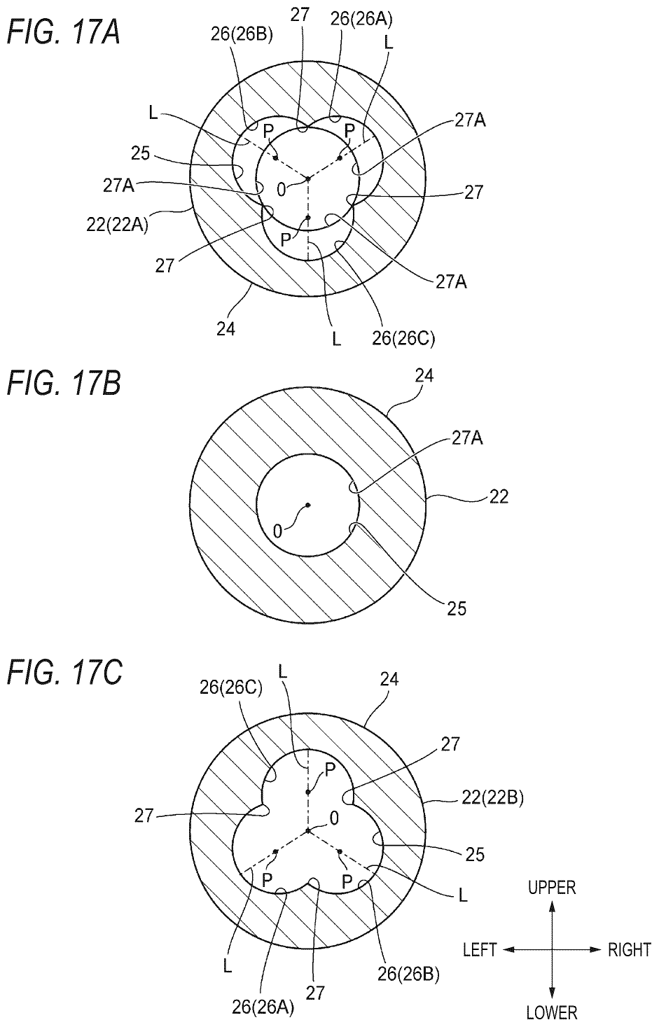

Specifically, also in the sixth embodiment, the crimped portion 22 of the terminal 20 includes a base part 22A and a distal part 22B as illustrated in FIG. 16, as in the fifth embodiment. The tubular inner space of the base part 22A and the tubular inner space of the distal part 22B are adjacent and communicate with each other at a boundary position z (see FIG. 16) between the base part 22A and the distal part 22B. As can be understood from comparison between FIG. 17A and FIG. 17C, the respective positions of the projecting portions 27 on the tubular inner face 25 of the base part 22A (three locations) and the positions of the projecting portions 27 on the tubular inner face 25 of the distal part 22B (three locations) are shifted by 180 degrees in the circumferential direction (the direction around the axis of the terminal 20).

In the base part 22A, as illustrated in FIGS. 16 and 17A, the distance between the center O and the center p of each of the three circular shapes 26 at the cross section of the tubular inner face 25 of the crimped portion 22 linearly increases from zero as the position in the axial direction of the terminal 20 (front-rear direction) approaches the base end side (rear end side) from the boundary position z. In the distal part 22B, as illustrated in FIG. 16 and FIG. 17C, the distance between the center O and the center p of each of the three circular shapes 26 at the cross section of the tubular inner face 25 of the crimped portion 22 gradually increases from zero as the position in the axial direction of the terminal 20 (front-rear direction) approaches the distal end side (front end side) from the boundary position z. In other words, the base part 22A has a shape in which the cross-sectional area of the tubular inner space decreases as approaching the distal part 22B, and the distal part 22B has a shape in which the cross-sectional area of the tubular inner space decreases as approaching the base part 22A. The tubular inner space of the base part 22A and the tubular inner space of the distal part 22B are adjacent and communicate with each other. As a result, as illustrated in FIG. 16, the tubular inner space is locally narrowed at the boundary position z, and the tubular inner face 25 at the boundary position z has a shape having projecting portions 27A, which are protruding strips that protrude radially inward (into the tubular portion) and extend over the entire circumference in the circumferential direction (the direction around the axis of the terminal 20), as in the fifth embodiment.

The tubular inner face 25 of the crimped portion 22 can be formed by, for example, arranging a drill whose outer diameter is equal to or smaller than the diameter of the circular shapes 26 such that the axis thereof is inclined relative to the axial direction of the terminal 20, and inserting the drill into the crimped portion 22 before the tubular inner face 25 is formed (solid) from the rear to perform cutting.

Specifically, the formation can be performed by, at locations on the tubular inner face 25 corresponding to circular shapes 26A at a cross section of the base part 22A (see FIG. 17A) and circular shapes 26A at a cross section of the distal part 22B (see FIG. 17C), arranging a drill whose outer diameter is equal to or smaller than the diameter of the circular shapes 26 such that the axis thereof is inclined rightward and upward on the base end side (rear end side) and inclined leftward and downward on the distal end side (front end side) relative to the axial direction of the terminal 20, and inserting the drill into the crimped portion 22 from the rear side to perform cutting. Further, the formation can be performed by, at locations corresponding to circular shapes 26B at a cross section of the base part 22A (see FIG. 17A) and circular shapes 26B at a cross section of the distal part 22B (see FIG. 17C), arranging a drill whose outer diameter is equal to or smaller than the diameter of the circular shapes 26 such that the axis thereof is inclined leftward and upward on the base end side (rear end side) and inclined rightward and downward on the distal end side (front end side) relative to the axial direction of the terminal 20, and inserting the drill into the crimped portion 22 from the rear side to perform cutting. Further, the formation can be performed by, at locations corresponding to circular shapes 26C at a cross section of the base part 22A (see FIG. 17A) and circular shapes 26C at a cross section of the distal part 22B (see FIG. 17C), arranging a drill whose outer diameter is equal to or smaller than the diameter of the circular shapes 26 such that the axis thereof is inclined downward on the base end side (rear end side) and inclined upward on the distal end side (front end side) relative to the axial direction of the terminal 20, and inserting the drill into the crimped portion 22 from the rear side to perform cutting. If using a drill whose outer diameter is equal to the diameter of the circular shapes 26, the tubular inner face 25 of the crimped portion 22 (that means combination of the base part 22A and the distal part 22B) can be formed by simply inserting the drill three times, corresponding to the three circular shapes 26, into the crimped portion 22.

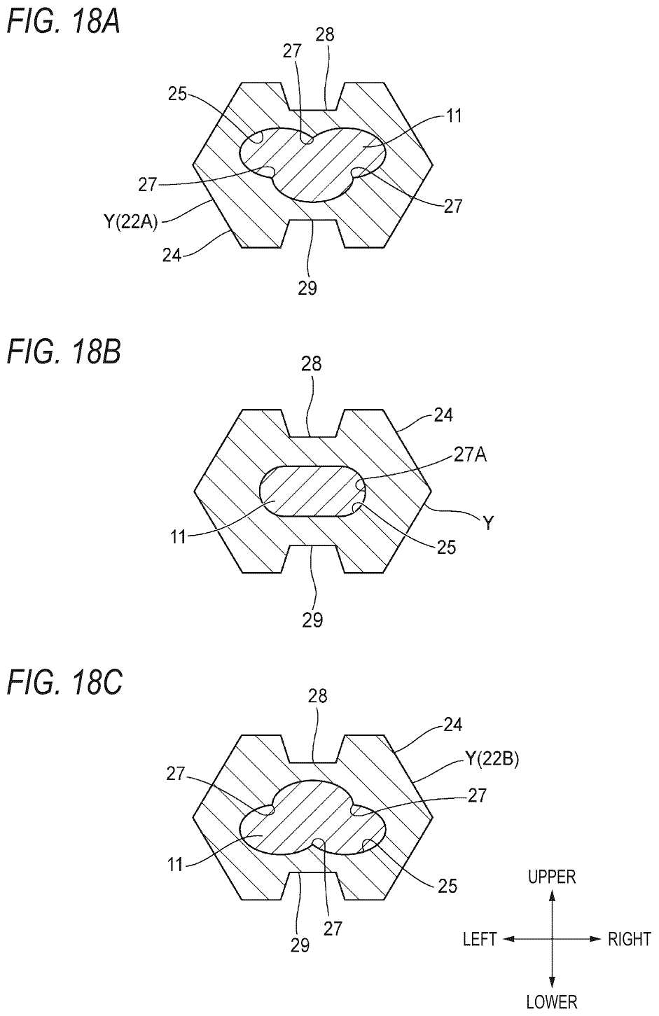

Also in the sixth embodiment, after crimping using the pair of upper and lower molds 30, 40 illustrated in FIG. 4, the projecting portions 27 of the tubular inner face 25 (three locations) bite into the conductor core wire 11 of the electrical wire 10 in both the base part 22A and the distal part 22B, as illustrated in FIGS. 18A to 18C. Accordingly, the projecting portions 27 of the crimped portion 22 (three locations) are strongly pressed against the conductor core wire 11. Further, at the boundary position z between the base part 22A and the distal part 22B, the projecting portions 27A of the tubular inner face 25 (see FIG. 16) also bite into the conductor core wire 11 of the electrical wire 10. This further increases the reliability of the electrical connection between the crimped portion 22 and the conductor core wire 11. Further, the respective positions of the projecting portions 27 on the tubular inner face 25 of the base part 22A (three locations) and the positions of the projecting portions 27 on the tubular inner face 25 of the distal part 22B (three locations) are different from each other in the circumferential direction (the direction around the axis of the terminal 20). Thereby, the projecting portions 27 of the base part 22A and the projecting portions 27 of the distal part bite into the conductor core wire 11 from different positions in the direction around the axis of the terminal 20. This increases the contact area and contact pressure between the crimped portion 22 and the conductor core wire 11 evenly in the direction around the axis of the terminal 20, thereby further increasing the reliability of the electrical connection between the crimped portion 22 and the conductor core wire 11.

### Seventh Embodiment

In the third embodiment, as illustrated in FIG. 9, in the tubular inner face 25 of the crimped portion 22 of the terminal 20, the overlapping locations of the four circular shapes 26 (four locations) respectively have the projecting portions 27, and the tubular inner face 25 of the crimped portion 22 has the same shape over the entire axial direction of the terminal 20 (front-rear direction), except for the base end described above. In other words, the distance between the center O and the center p of each of the four circular shapes 26 at the cross section of the tubular inner face 25 of the crimped portion 22 is constant regardless of the position in the axial direction of the terminal 20 (front-rear direction), except for the base end described above.

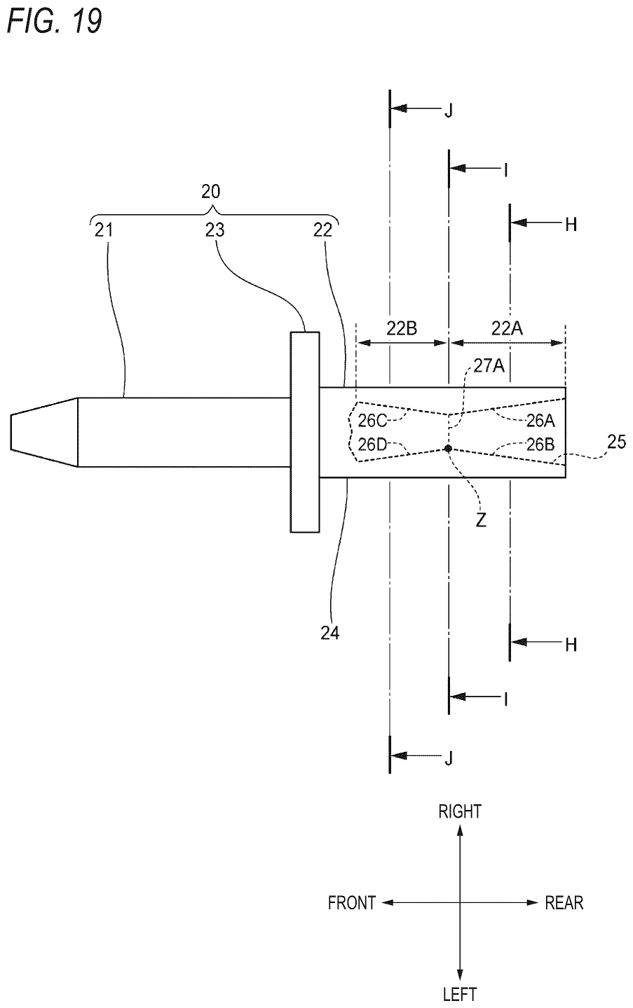

On the other hand, the seventh embodiment illustrated in FIGS. 19 to 21C is the same as the third embodiment in that the overlapping locations of the four circular shapes 26 (four locations) on the tubular inner face 25 of the crimped portion 22 respectively have the projecting portions 27, and is different from the third embodiment in that the distance between the center O and the center p of each of the four circular shapes 26 at the cross section of the tubular inner face 25 of the crimped portion 22 changes depending on the position in the axial direction of the terminal 20 (front-rear direction).

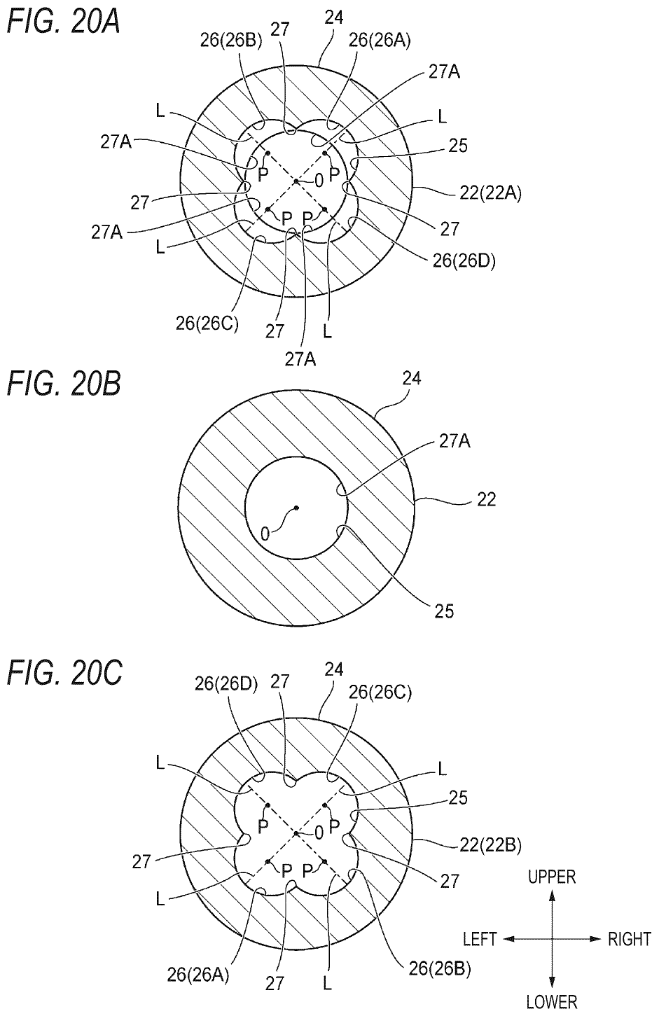

Specifically, also in the seventh embodiment, the crimped portion 22 of the terminal 20 includes a base part 22A and a distal part 22B as illustrated in FIG. 19, as in the fifth embodiment. The tubular inner space of the base part 22A and the tubular inner space of the distal part 22B are adjacent and communicate with each other at a boundary position z (see FIG. 19) between the base part 22A and the distal part 22B. As can be understood from comparison between FIG. 20A and FIG. 20C, the respective positions of the projecting portions 27 on the tubular inner face 25 of the base part 22A (four locations) and the positions of the projecting portions 27 on the tubular inner face 25 of the distal part 22B (four locations) coincide with each other in the circumferential direction (the direction around the axis of the terminal 20).

In the base part 22A, as illustrated in FIG. 19 and FIG. 20A, the distance between the center O and the center p of each of the four circular shapes 26 at the cross section of the tubular inner face 25 of the crimped portion 22 linearly increases from zero as the position in the axial direction of the terminal 20 (front-rear direction) approaches the base end side (rear end side) from the boundary position z. In the distal part 22B, as illustrated in FIGS. 19 and 20C, the distance between the center O and the center p of each of the four circular shapes 26 at the cross section of the tubular inner face 25 of the crimped portion 22 gradually increases from zero as the position in the axial direction of the terminal 20 (front-rear direction) approaches the distal end side (front end side) from the boundary position z. In other words, the base part 22A has a shape in which the cross-sectional area of the tubular inner space decreases as approaching the distal part 22B, and the distal part 22B has a shape in which the cross-sectional area of the tubular inner space decreases as approaching the base part 22A. The tubular inner space of the base part 22A and the tubular inner space of the distal part 22B are adjacent and communicate with each other. As a result, as illustrated in FIG. 19, the tubular inner space is locally narrowed at the boundary position z, and the tubular inner face 25 at the boundary position z has a shape having projecting portions 27A, which are protruding strips that protrude radially inward (into the tubular portion) and extend over the entire circumference in the circumferential direction (the direction around the axis of the terminal 20) as in the fifth embodiment.

The tubular inner face 25 of the crimped portion 22 can be formed by, for example, arranging a drill whose outer diameter is equal to or smaller than the diameter of the circular shapes 26 such that the axis thereof is inclined relative to the axial direction of the terminal 20, and inserting the drill into the crimped portion 22 before the tubular inner face 25 is formed (solid) from the rear to perform cutting.

Specifically, the formation can be performed by, at locations on the tubular inner face 25 corresponding to circular shapes 26A at a cross section of the base part 22A (see FIG. 20A) and circular shapes 26A at a cross section of the distal part 22B (see FIG. 20C), arranging a drill whose outer diameter is equal to or smaller than the diameter of the circular shapes 26 such that the axis thereof is inclined rightward and upward on the base end side (rear end side) and inclined leftward and downward on the distal end side (front end side) relative to the axial direction of the terminal 20, and inserting the drill into the crimped portion 22 from the rear side to perform cutting. Further, the formation can be performed by, at locations corresponding to circular shapes 26B at a cross section of the base part 22A (see FIG. 20A) and circular shapes 26B at a cross section of the distal part 22B (see FIG. 20C), arranging a drill whose outer diameter is equal to or smaller than the diameter of the circular shapes 26 such that the axis thereof is inclined leftward and upward on the base end side (rear end side) and inclined rightward and downward on the distal end side (front end side) relative to the axial direction of the terminal 20, and inserting the drill into the crimped portion 22 from the rear side to perform cutting. Further, the formation can be performed by, at locations corresponding to circular shapes 26C at a cross section of the base part 22A (see FIG. 20A) and circular shapes 26C at a cross section of the distal part 22B (see FIG. 20C), arranging a drill whose outer diameter is equal to or smaller than the diameter of the circular shapes 26 such that the axis thereof is inclined leftward and downward on the base end side (rear end side) and inclined rightward and upward on the distal end side (front end side) relative to the axial direction of the terminal 20, and inserting the drill into the crimped portion 22 from the rear side to perform cutting. Further, the formation can be performed by, at locations corresponding to circular shapes 26D at a cross section of the base part 22A (see FIG. 20A) and circular shapes 26D at a cross section of the distal part 22B (see FIG. 20C), arranging a drill whose outer diameter is equal to or smaller than the diameter of the circular shapes 26 such that the axis thereof is inclined rightward and downward on the base end side (rear end side) and inclined leftward and upward on the distal end side (front end side) relative to the axial direction of the terminal 20, and inserting the drill into the crimped portion 22 from the rear side to perform cutting. If using a drill whose outer diameter is equal to the diameter of the circular shapes 26, the tubular inner face 25 of the crimped portion 22 (that means combination of the base part 22A and the distal part 22B) can be formed by simply inserting the drill four times, corresponding to the four circular shapes 26, into the crimped portion 22.

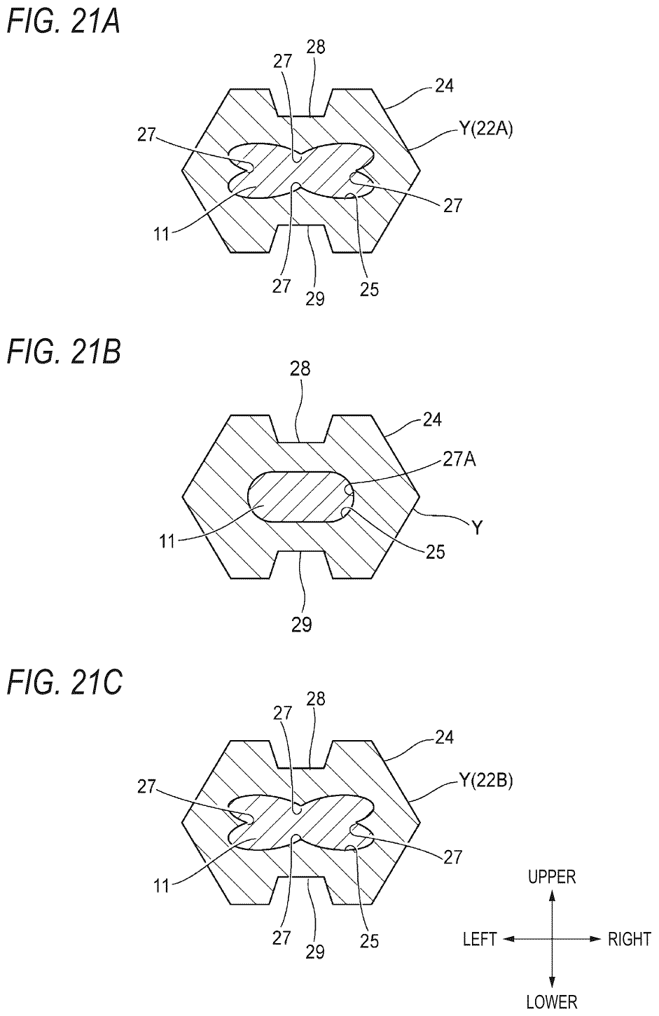

Also in the seventh embodiment, after crimping using the pair of upper and lower molds 30, 40 illustrated in FIG. 4, the projecting portions 27 of the tubular inner face 25 (four locations) bite into the conductor core wire 11 of the electrical wire 10 in both the distal part 22B and the base part 22A, as illustrated in FIG. 21. Accordingly, the projecting portions 27 of the crimped portion 22 (four locations) are strongly pressed against the conductor core wire 11. Further, at the boundary position z between the distal part 22B and the base part 22A, the projecting portions 27A of the tubular inner face 25 (see FIG. 19) also bite into the conductor core wire 11 of the electrical wire 10. This further increases the reliability of the electrical connection between the crimped portion 22 and the conductor core wire 11.

### Eighth Embodiment

In the fourth embodiment, as illustrated in FIG. 11, in the tubular inner face 25 of the crimped portion 22 of the terminal 20, the overlapping locations of the one large circular shape 51 and the four small circular shapes 26 (eight locations) respectively have the projecting portions 27, and the tubular inner face 25 of the crimped portion 22 has the same shape over the entire axial direction of the terminal 20 (front-rear direction), except for the base end described above. In other words, the distance between the center O and the center p of each of the four circular shapes 26 at the cross section of the tubular inner face 25 of the crimped portion 22 is constant regardless of the position in the axial direction of the terminal 20 (front-rear direction), except for the base end described above.

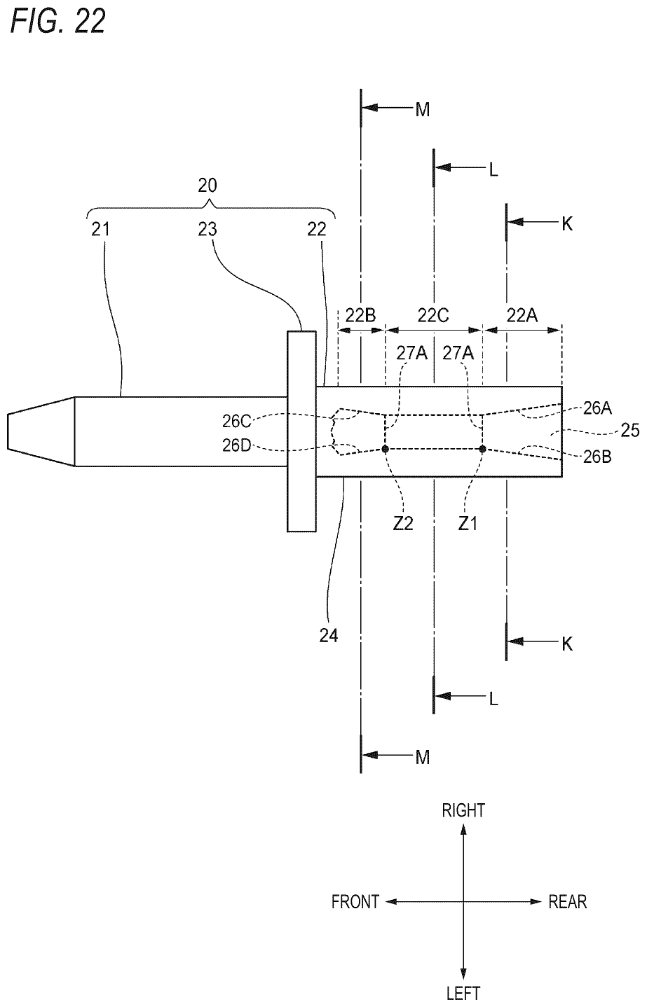

On the other hand, the eighth embodiment illustrated in FIGS. 22 to 24C is the same as the fourth embodiment in that the overlapping locations of the one large circular shape 51 and the four small circular shapes 26 (eight locations) on the tubular inner face 25 of the crimped portion 22 respectively have the projecting portions 27, and is different from the fourth embodiment in that the distance between the center O and the center p of each of the four circular shapes 26 at the cross section of the tubular inner face 25 of the crimped portion 22 changes depending on the position in the axial direction of the terminal 20 (front-rear direction).

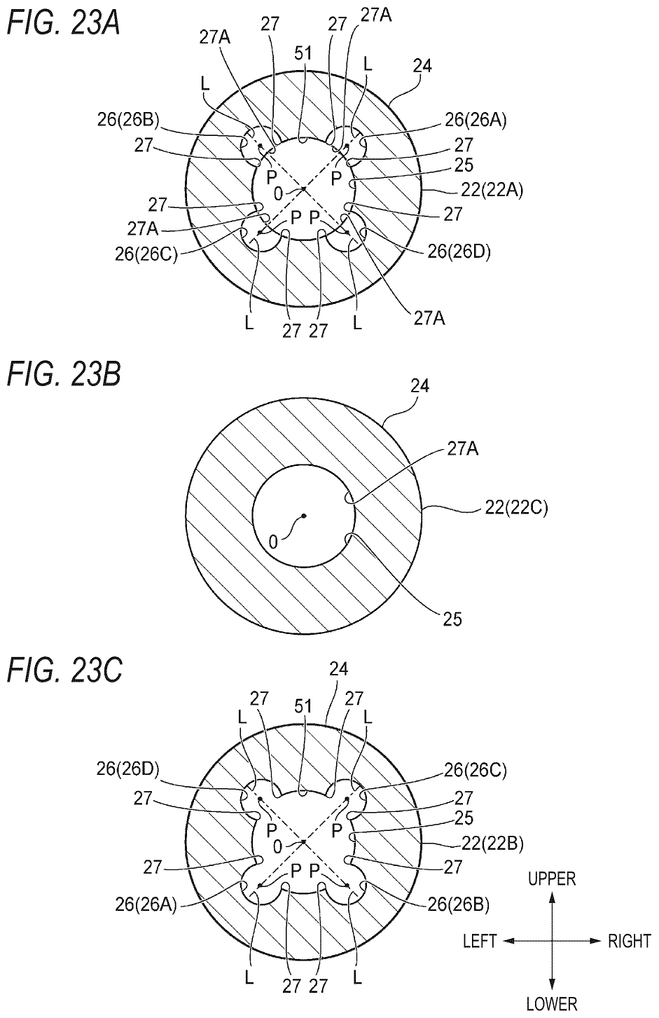

Specifically, as illustrated in FIG. 22, the eighth embodiment is different from the fifth to seventh embodiments in that an intermediate part 22C is interposed between the base part 22A and the distal part 22B in the crimped portion 22 of the terminal 20, and the crimped portion 22 of the terminal 20 is formed by the base part 22A, the intermediate part 22C, and the distal part 22B which are aligned in the axial direction of the terminal 20 from the base end side toward the distal end side. The tubular inner space of the base part 22A and the tubular inner space of the intermediate part 22C are adjacent and communicate with each other at a boundary position z1 (see FIG. 22) between the base part 22A and the intermediate part 22C. The tubular inner space of the distal part 22B and the tubular inner space of the intermediate part 22C are adjacent and communicate with each other at a boundary position z2 (see FIG. 22) between the distal part 22B and the intermediate part 22C. As can be understood from FIG. 23A to FIG. 23C, the tubular inner face 25 is formed with the projecting portions 27 (eight locations) in both the base part 22A and the distal part 22B, but is not formed with the projecting portions 27 in the intermediate part 22C. In the intermediate part 22C, the cross section of the tubular inner face 25 is formed by only one large circular shape 51 extending over the entire axial direction of the terminal 20 (front-rear direction) (see FIG. 23B). As can be understood from comparison between FIG. 23A and FIG. 23C, the respective positions of the projecting portions 27 on the tubular inner face 25 of the base part 22A (eight locations) and the positions of the projecting portions 27 on the tubular inner face 25 of the distal part 22B (eight locations) coincide with each other in the circumferential direction (the direction around the axis of the terminal 20).

In the base part 22A, as illustrated in FIG. 22 and FIG. 23A, the distance between the center O and the center p of each of the four circular shapes 26 at the cross section of the tubular inner face 25 of the crimped portion 22 linearly increases from zero as the position in the axial direction of the terminal 20 (front-rear direction) approaches the base end side (rear end side) from the boundary position z1. In the distal part 22B, as illustrated in FIGS. 22 and 23C, the distance between the center O and the center p of each of the four circular shapes 26 at the cross section of the tubular inner face 25 of the crimped portion 22 gradually increases from zero as the position in the axial direction of the terminal 20 (front-rear direction) approaches the distal end side (front end side) from the boundary position z2. In other words, the base part 22A has a shape in which the cross-sectional area of the tubular inner space decreases as approaching the distal part 22B, and the distal part 22B has a shape in which the cross-sectional area of the tubular inner space decreases as approaching the base part 22A. The tubular inner space of the base part 22A and the tubular inner space of the distal part 22B communicate with each other via the tubular inner space of the intermediate part 22C. As a result, as illustrated in FIG. 22, the tubular inner face 25 has a shape having projecting portions 27A, which are protruding strips that protrude radially inward (into the tubular portion) and extend in the circumferential direction (the direction around the axis of the terminal 20), at the respective positions in the circumferential direction (the direction around the axis of the terminal 20) in which the four circular shapes 26 are positioned at both the boundary position z1 and the boundary position z2.

The tubular inner face 25 of the crimped portion 22 can be formed by, for example, arranging a first drill whose outer diameter is equal to or smaller than the diameter of the circular shape 51 such that the axis thereof is parallel to the axial direction of the terminal 20, and inserting the drill into the crimped portion 22 before the tubular inner face 25 is formed (solid) from the rear to perform cutting, and arranging a second drill whose outer diameter is equal to or smaller than the diameter of the circular shapes 26 such that the axis thereof is inclined relative to the axial direction of the terminal 20, and inserting the drill into the crimped portion 22 before the tubular inner face 25 is formed from the rear to perform cutting.

Specifically, first, by using the first drill, a columnar hole whose cross section is the circular shape 51 is formed over the entire base part 22A, intermediate part 22C, and distal part 22B in the axial direction of the terminal 20, whereby the tubular inner face 25 of the intermediate part 22C is formed as a part of the columnar hole in the axial direction. Specifically, the formation can be performed by, at locations on the tubular inner face 25 corresponding to circular shapes 26A at a cross section of the base part 22A (see FIG. 23A) and circular shapes 26A at a cross section of the distal part 22B (see FIG. 23C), arranging a second drill such that the axis thereof is inclined rightward and upward on the base end side (rear end side) and inclined leftward and downward on the distal end side (front end side) relative to the axial direction of the terminal 20, and inserting the drill into the crimped portion 22 from the rear side to perform cutting. Further, the formation can be performed by, at locations corresponding to circular shapes 26B at a cross section of the base part 22A (see FIG. 23A) and circular shapes 26B at a cross section of the distal part 22B (see FIG. 23C), arranging a second drill such that the axis thereof is inclined leftward and upward on the base end side (rear end side) and inclined rightward and downward on the distal end side (front end side) relative to the axial direction of the terminal 20, and inserting the drill into the crimped portion 22 from the rear side to perform cutting. Further, the formation can be performed by, at locations corresponding to circular shapes 26C at a cross section of the base part 22A (see FIG. 23A) and circular shapes 26C at a cross section of the distal part 22B (see FIG. 23C), arranging a second drill such that the axis thereof is inclined leftward and downward on the base end side (rear end side) and inclined rightward and upward on the distal end side (front end side) relative to the axial direction of the terminal 20, and inserting the drill into the crimped portion 22 from the rear side to perform cutting. Further, the formation can be performed by, at locations corresponding to circular shapes 26D at a cross section of the base part 22A (see FIG. 23A) and circular shapes 26D at a cross section of the distal part 22B (see FIG. 23C), arranging a second drill such that the axis thereof is inclined rightward and downward on the base end side (rear end side) and inclined leftward and upward on the distal end side (front end side) relative to the axial direction of the terminal 20, and inserting the drill into the crimped portion 22 from the rear side to perform cutting. If using a first drill whose outer diameter is equal to the diameter of the circular shape 51 and a second drill whose outer diameter is equal to the diameter of the circular shapes 26, the tubular inner face 25 of the crimped portion 22 can be formed by simply inserting the first drill once, corresponding to the one circular shape 51, and inserting the second drill four times, corresponding to the four circular shapes 26, into the crimped portion 22 (that means combination of the base part 22A, the intermediate part 22C, and the distal part 22B) before the tubular inner face 25 is formed.

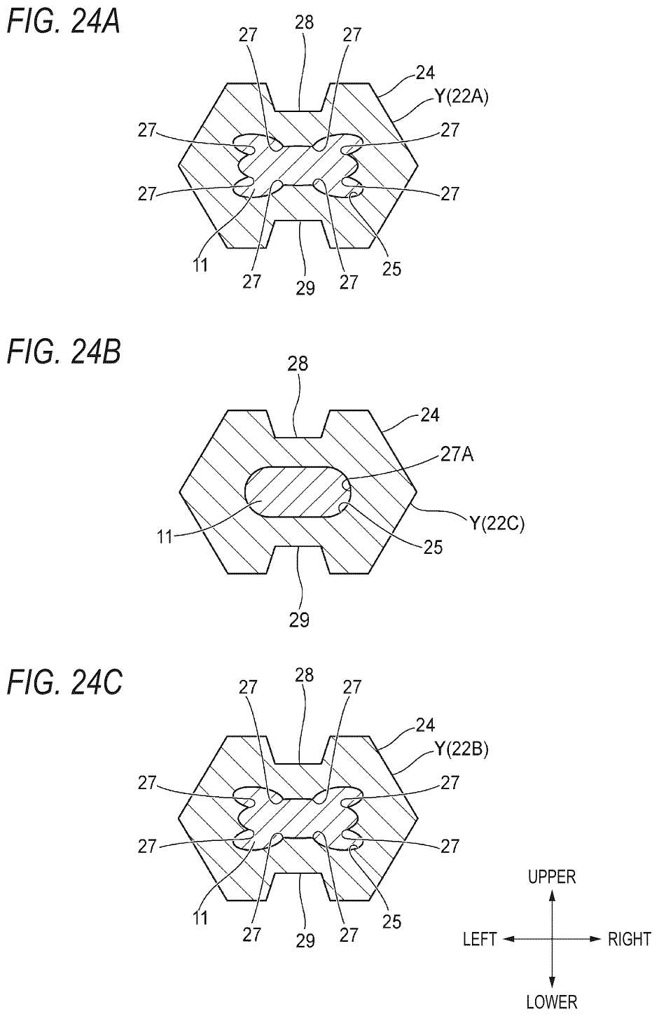

Also in the eighth embodiment, after crimping using the pair of upper and lower molds 30, 40 illustrated in FIG. 4, the projecting portions 27 of the tubular inner face 25 (eight locations) bite into the conductor core wire 11 of the electrical wire 10 in both the base part 22A and the distal part 22B, as illustrated in FIGS. 24A to 24C. Accordingly, the projecting portions 27 of the crimped portion 22 (eight locations) are strongly pressed against the conductor core wire 11. Further, at both the boundary position z1 between the base part 22A and the intermediate part 22C and the boundary position z2 between the distal part 22B and the intermediate part 22C, the projecting portions 27A of the tubular inner face 25 (see FIG. 22) also bite into the conductor core wire 11 of the electrical wire 10. This further increases the reliability of the electrical connection between the crimped portion 22 and the conductor core wire 11.

### Operation and Effect

As described above, according to the method for manufacturing the electrical wire with terminal 1, the terminal 20, and the electrical wire with terminal 1 according to the present embodiment, the crimped portion 22 of the terminal 20 has a tubular shape continuous without a slit in the circumferential direction, and has, at a cross section orthogonal to the axis of the terminal 20 (front-rear direction), a shape before crimping in which the tubular inner face 25 of the crimped portion 22 has the projecting portions 27 protruding into the tubular portion. Thus, when the crimped portion 22 is deformed into the tubular portion using the caulking tool (the pair of upper and lower molds 30, 40), the crimped portion 22 is crimped to the conductor core wire 11 in a shape in which the projecting portions 27 of the tubular inner face 25 of the crimped portion 22 bite into the conductor core wire 11 of the electrical wire 10. Further, the projecting portions 27 of the tubular inner face 25 of the crimped portion 22 are strongly pressed against the conductor core wire 11. Accordingly, the contact area and the contact pressure between the crimped portion 22 and the conductor core wire 11 increase as compared with a case without a projecting portion on the tubular inner face 25 of the crimped portion 22. This increases the reliability of the electrical connection between the crimped portion 22 and the conductor core wire 11. Therefore, according to the manufacturing method and the terminal 20 according to the present embodiment, it is possible to manufacture an electrical wire with terminal 1 that can improve the reliability of the electrical connection between the terminal 20 and the electrical wire 10. According to the electrical wire with terminal 1 according to the present embodiment, it is possible to improve the reliability of the electrical connection between the terminal 20 and the electrical wire 10.

Further, the caulking tool (the pair of upper and lower molds 30, 40) has the protruding portions 32, 42 on the caulking faces 31, 41 to recess the crimped portion 22 into the tubular portion of the crimped portion 22. As a result, the crimped portion 22 is recessed into the tubular portion at the time of crimping, so that the crimped portion 22 is crimped to the conductor core wire 11 in a shape in which the projecting portions 27 of the tubular inner face 25 bite more deeply into the conductor core wire 11 of the electrical wire 10, and the projecting portions 27 of the tubular inner face 25 are more strongly pressed against the conductor core wire 11. Thus, according to the manufacturing method of the present embodiment, it is possible to manufacture an electrical wire with terminal 1 that can further improve the reliability of the electrical connection between the terminal 20 and the electrical wire 10. According to the electrical wire with terminal 1 according to the present embodiment, it is possible to improve the reliability of the electrical connection between the terminal 20 and the electrical wire 10.

### Other Embodiments

The present disclosure is not limited to the embodiments described above, and various modifications can be adopted within the scope of the present disclosure. For example, the present disclosure is not limited to the embodiments described above, and modifications, improvements, and the like can be appropriately made. In addition, materials, shapes, sizes, numbers, arrangement locations, or the like of components in the embodiments described above are freely selected and are not limited as long as the present disclosure can be implemented.

For example, in the first embodiment to eighth embodiment, the pair of upper and lower molds 30, 40 used when caulking the crimped portion 22 of the terminal 20 are formed such that the entire caulking faces have a hexagonal cross-sectional shape when clamped (see FIG. 4). Alternatively, the pair of upper and lower molds 30, 40 may be configured such that the entire caulking faces have a cross-sectional shape other than hexagonal (for example, square, semicircular, crescent shape, or the like) when clamped. In this case, the outer face 24 of the crimped portion 22 after crimping has a cross-sectional shape other than hexagonal, corresponding to the cross-sectional shape of the entire caulking faces of the molds 30, 40.

Further, in the first embodiment to eighth embodiment, the protruding portions 32, 42 are respectively provided on the caulking faces 31, 41 of the pair of upper and lower molds 30, 40 used when caulking the crimped portion 22 of the terminal 20. Alternatively, the caulking face 31 of the mold 30 may not be provided with the protruding portion 32, and/or the caulking face 41 of the mold 40 may not be provided with the protruding portion 42. In this case, the outer face 24 of the crimped portion 22 after crimping is not formed with either one or both of the recessed portions 28, 29.

Further, in the first embodiment to eighth embodiment, the tubular inner face 25 of the crimped portion 22 has, at the cross section, a shape in which a plurality of circular shapes are combined while partially overlapping each other. Alternatively, the tubular inner face 25 of the crimped portion 22 may have a shape in which a plurality of elliptical shapes are combined while partially overlapping each other, or a shape in which one or a plurality of circular shapes and one or a plurality of elliptical shapes are combined while partially overlapping each other. If combining a plurality of circular shape or elliptical shapes in this way, it is preferable that the tubular inner face 25 has two or more projecting portions 27 (that is, the tubular inner face 25 after crimping also has two or more projecting portions 27).

Further, in the fifth, seventh, and eighth embodiments, the positions of the projecting portions 27 on the tubular inner face 25 of the base part 22A and the positions of the projecting portions 27 on the tubular inner face 25 of the distal part 22B coincide with each other in the circumferential direction (the direction around the axis of the terminal 20). In the above sixth embodiment, the positions of the projecting portions 27 on the tubular inner face 25 of the base part 22A and the positions of the projecting portions 27 on the tubular inner face 25 of the distal part 22B are shifted by 180 degrees in the circumferential direction (the direction around the axis of the terminal 20). Alternatively, the tubular inner face 25 may be formed such that the positions of the projecting portions 27 on the tubular inner face 25 of the base part 22A and the positions of the projecting portions 27 on the tubular inner face 25 of the distal part 22B are shifted by any angle in the circumferential direction (the direction around the axis of the terminal 20). Such a tubular inner face 25 can be formed by, for example, preparing the base part 22A and the distal part 22B as separate members, perform cutting to form the tubular inner face 25 in both the base part 22A and the distal part 22B, then positioning the base part 22A and the distal part 22B such that the positions of the projecting portions 27 are shifted by any angle, and joining the base part 22A and the distal part 22B.

Here, a method for manufacturing the electrical wire with terminal 1 according to the present disclosure described above, a terminal, and a feature of an embodiment of an electrical wire with terminal are briefly summarized and listed in a first to fifteenth aspects, respectively.

According to the first aspect of the present disclosure, there is provided a method for manufacturing an electrical wire with terminal (1) in which a terminal (20) is crimped to a conductor core wire (11) of an electrical wire (10). The terminal (20) includes a connected portion (21) configured to be connected to a mating terminal and a crimped portion (22) configured to be crimped to the conductor core wire (11). The crimped portion (22) has a tubular shape continuous without a slit in a circumferential direction, and has, at a cross section orthogonal to an axis of the terminal (20), a shape before crimping in which a tubular inner face (25) of the crimped portion (22) includes a projecting portion (27) protruding into a tubular portion. The manufacturing method includes: inserting the conductor core wire (11) into the tubular portion of the crimped portion (22); and crimping the crimped portion (22) to the conductor core wire (11) by caulking the crimped portion (22) using a caulking tool (30, 40), the caulking tool (30, 40) being configured to deform the crimped portion (22) into the tubular portion by pressing a caulking face (31, 41) against the crimped portion (22).

According to the method for manufacturing the electrical wire with terminal having the configuration of the above first aspect, the crimped portion of the terminal has a tubular shape continuous without a slit in the circumferential direction (so-called closed barrel shape), and has, at a cross section orthogonal to the axis of the terminal, a shape before crimping in which the tubular inner face of the crimped portion has a projecting portion protruding into the tubular portion. Accordingly, when the crimped portion is deformed into the tubular portion using the caulking tool, the crimped portion is crimped to the conductor core wire in a shape in which the projecting portion of the tubular inner face of the crimped portion bites into the conductor core wire. Further, the projecting portion of the tubular inner face of the crimped portion is strongly pressed against the conductor core wire. Accordingly, the contact area and the contact pressure between the crimped portion and the conductor core wire increase as compared with a case without a projecting portion on the tubular inner face of the crimped portion. This increases the reliability of the electrical connection between the crimped portion and the conductor core wire. Therefore, according to the manufacturing method of the present configuration, it is possible to manufacture an electrical wire with terminal that can improve the reliability of the electrical connection between the terminal and the electrical wire.

According to the second aspect of the present disclosure, in the manufacturing method according to the above first aspect, the tubular inner face (25) of the crimped portion (22) has, at the cross section: a shape in which a plurality of circular shapes (26) are combined while partially overlapping each other, a shape in which a plurality of elliptical shapes are combined while partially overlapping each other, or a shape in which one or a plurality of circular shapes (26) and one or a plurality of elliptical shapes are combined while partially overlapping each other.

According to the method for manufacturing an electrical wire with terminal having the configuration of the above second aspect, the tubular inner face of the crimped portion has a shape in which a plurality of circular shapes and/or elliptical shapes are combined while partially overlapping each other. As a result, an overlapping location of the circular shapes and/or elliptical shapes is formed with the projecting portion in which the tubular inner face protrudes into the tubular portion. Furthermore, by forming the tubular inner face of the crimped portion into a combination of circular shapes, the hole of the crimped portion can be easily formed by a drill or the like when manufacturing the terminal by cutting, for example.

According to the third aspect of the present disclosure, in the manufacturing method according to the above first aspect, the crimped portion (22) includes a first part (22A) and a second part (22B) that are aligned in a direction of the axis. The first part (22A) has a shape in which a cross-sectional area at the cross section of the tubular inner space decreases as approaching the second part (22B). The second part (22B) has a shape in which a cross-sectional area at the cross section of the tubular inner space decreases as approaching the first part (22A).

According to the fourth aspect of the present disclosure, in the manufacturing method according to the above third aspect, the tubular inner space of the first part (22A) and the tubular inner space of the second part (22B) are adjacent and communicate with each other, or the tubular inner space of the first part (22A) and the tubular inner space of the second part (22B) communicate with each other via another tubular inner space.

According to the method for manufacturing the electrical wire with terminal having the configuration of the above third and fourth aspects, the tubular inner space of the first part of the crimped portion is gradually smaller as approaching the second part, and the tubular inner space of the second part of the crimped portion is gradually smaller as approaching the first part. Therefore, if the tubular inner space of the first part and the tubular inner space of the second part are adjacent and communicate with each other, there is a location where the tubular inner space is locally narrowed at the boundary between the first part and the second part. At this location, similar to the projecting portion described above, the tubular inner face has a shape protruding into the tubular portion. On the other hand, if the tubular inner space of the first part and the tubular inner space of the second part communicate with each other via another tubular inner space, there is a location where the tubular inner space is locally narrowed at the boundary between the first part and the part defining the other tubular inner space and the boundary between the second part and the part defining the other tubular inner space. Accordingly, at the time of crimping, the tubular inner face at this location is strongly pressed against the conductor core wire similarly as the projecting portion described above. Further, the tubular inner face of the first part and the tubular inner face of the second part are inclined relative to the conductor core wire of the electrical wire, thereby increasing the contact area between the tubular inner face and the conductor core wire. This further increases the reliability of the electrical connection between the crimped portion and the conductor core wire.

According to the fifth aspect of the present disclosure, in the manufacturing method according to the above third aspect, a position of the projecting portion (27) in the tubular inner face (25) of the first part (22A) and a position of the projecting portion (27) in the tubular inner face (25) of the second part (22B) are different in a direction around the axis.

According to the method for manufacturing the electrical wire with terminal having the configuration of the above fifth aspect, at the time of crimping, the projecting portion of the first part and the projecting portion of the second part bite into the conductor core wire from different positions in the direction around the axis. This increases the contact area and contact pressure between the crimped portion and the conductor core wire evenly in the direction around the axis, thereby further increasing the reliability of the electrical connection between the crimped portion and the conductor core wire.

According to the sixth aspect of the present disclosure, in the manufacturing method according to any one of the above first to fifth aspects, the caulking tool (30, 40) has a protruding portion (32, 42) on the caulking face (31, 41) to recess the crimped portion (22) into the tubular portion of the crimped portion (22).

According to the method for manufacturing the electrical wire with terminal having the configuration of the above sixth aspect, the caulking tool has the protruding portion on the caulking face to recess the crimped portion into the tubular portion of the crimped portion. Accordingly, the crimped portion is recessed into the tubular portion at the time of crimping, so that the crimped portion is crimped to the conductor core wire in a shape in which the projecting portion of the tubular inner face bites more deeply into the conductor core wire of the electrical wire, and the projecting portion of the tubular inner face is more strongly pressed against the conductor core wire. Thus, according to the manufacturing method of the present configuration, it is possible to manufacture an electrical wire with terminal that can further enhance the reliability of the electrical connection between the terminal and the electrical wire.

According to the seventh aspect of the present disclosure, a terminal (20) configured to be crimped to a conductor core wire (11) of an electrical wire (10) includes: a connected portion (21) configured to be connected to a mating terminal; and a crimped portion (22) configured to be crimped to the conductor core wire (11). The crimped portion (22) has a tubular shape continuous without a slit in a circumferential direction, and has, at a cross section orthogonal to an axis of the terminal (20), a shape before crimping in which a tubular inner face (25) of the crimped portion (22) includes a projecting portion (27) protruding into the tubular portion.

According to the terminal having the configuration of the above seventh aspect, the crimped portion of the terminal has a tubular shape continuous without a slit in the circumferential direction (so-called closed barrel shape), and has, at a cross section orthogonal to the axis of the terminal, a shape before crimping in which the tubular inner face of the crimped portion has a projecting portion protruding into the tubular portion. Accordingly, when the crimped portion is deformed into the tubular portion using the caulking tool, the crimped portion is crimped to the conductor core wire in a shape in which the projecting portion of the tubular inner face of the crimped portion bites into the conductor core wire. Further, the projecting portion of the tubular inner face of the crimped portion is strongly pressed against the conductor core wire. Accordingly, the contact area and the contact pressure between the crimped portion and the conductor core wire increase as compared with a case without a projecting portion on the tubular inner face of the crimped portion. This increases the reliability of the electrical connection between the crimped portion and the conductor core wire. Therefore, according to the terminal of the present configuration, it is possible to manufacture an electrical wire with terminal that can improve the reliability of the electrical connection between the terminal and the electrical wire.

According to the eighth aspect of the present disclosure, in the terminal (20) according to the above seventh aspect, the tubular inner face (25) of the crimped portion (22) has, at the cross section: a shape in which a plurality of circular shapes (26) are combined while partially overlapping each other, a shape in which a plurality of elliptical shapes are combined while partially overlapping each other, or a shape in which one or a plurality of circular shapes (26) and one or a plurality of elliptical shapes are combined while partially overlapping each other.

According to the terminal having the configuration of the above eighth aspect, the tubular inner face of the crimped portion has a shape in which a plurality of circular shapes and/or elliptical shapes are combined while partially overlapping each other. As a result, an overlapping location of the circular shapes and/or elliptical shapes is formed with the projecting portion in which the tubular inner face protrudes into the tubular portion. Furthermore, by forming the tubular inner face of the crimped portion into a combination of circular shapes, the hole of the crimped portion can be easily formed by a drill or the like when manufacturing the terminal by cutting, for example.

According to the ninth aspect of the present disclosure, in the terminal (20) according to the above seventh aspect, the crimped portion (22) includes a first part (22A) and a second part (22B) that are aligned in a direction of the axis. The first part (22A) has a shape in which a cross-sectional area at the cross section of the tubular inner space decreases as approaching the second part (22B). The second part (22B) has a shape in which a cross-sectional area at the cross section of the tubular inner space decreases as approaching the first part (22A).

According to the tenth aspect of the present disclosure, in the terminal (20) according to the above ninth aspect, the tubular inner space of the first part (22A) and the tubular inner space of the second part (22B) are adjacent and communicate with each other, or the tubular inner space of the first part (22A) and the tubular inner space of the second part (22B) communicate with each other via another tubular inner space.

According to the terminal having the configuration of the above ninth and tenth aspects, the tubular inner space of the first part of the crimped portion is gradually smaller as approaching the second part, and the tubular inner space of the second part of the crimped portion is gradually smaller as approaching the first part. Therefore, if the tubular inner space of the first part and the tubular inner space of the second part are adjacent and communicate with each other, there is a location where the tubular inner space is locally narrowed at the boundary between the first part and the second part. At this location, similar to the projecting portion described above, the tubular inner face has a shape protruding into the tubular portion. On the other hand, if the tubular inner space of the first part and the tubular inner space of the second part communicate with each other via another tubular inner space, there is a location where the tubular inner space is locally narrowed at the boundary between the first part and the part defining the other tubular inner space and the boundary between the second part and the part defining the other tubular inner space. Accordingly, at the time of crimping, the tubular inner face at this location is strongly pressed against the conductor core wire similarly as the projecting portion described above. Further, the tubular inner face of the first part and the tubular inner face of the second part are inclined relative to the conductor core wire of the electrical wire, thereby increasing the contact area between the tubular inner face and the conductor core wire. This further increases the reliability of the electrical connection between the crimped portion and the conductor core wire.

According to the eleventh aspect of the present disclosure, in the terminal (20) according to the above ninth aspect, a position of the projecting portion (27) in the tubular inner face (25) of the first part (22A) and a position of the projecting portion (27) in the tubular inner face (25) of the second part (22B) are different in a direction around the axis.

According to the terminal having the configuration of the above eleventh aspect, at the time of crimping, the projecting portion of the first part and the projecting portion of the second part bite into the conductor core wire from different positions in the direction around the axis. This increases the contact area and contact pressure between the crimped portion and the conductor core wire evenly in the direction around the axis, thereby further increasing the reliability of the electrical connection between the crimped portion and the conductor core wire.

According to the twelfth aspect of the present disclosure, an electrical wire with terminal (1) includes: an electrical wire (10); and a terminal (20) crimped to a conductor core wire (11) of the electrical wire (10). The terminal (20) includes: a connected portion (21) configured to be connected to a mating terminal; and a crimped portion (22) crimped to the conductor core wire (11). The crimped portion (22) has a tubular shape continuous without a slit in a circumferential direction, and has, at a cross section orthogonal to an axis of the terminal (20), a shape in which a tubular inner face (25) of the crimped portion (22) has a plurality of curved faces convex out of a tubular portion. A location where one of the curved faces and another of the curved faces are coupled defines, at the cross section, a projecting portion (27) protruding into the tubular portion of the crimped portion (22).

According to the electrical wire with terminal having the configuration of the above twelfth aspect, the crimped portion of the terminal has a tubular shape continuous without a slit in the circumferential direction (so-called closed barrel shape), and has, at a cross section orthogonal to the axis of the terminal, a shape before crimping in which the tubular inner face of the crimped portion has a projecting portion protruding into the tubular portion. As a result, the crimped portion is crimped to the conductor core wire in a shape in which the projecting portion of the tubular inner face of the crimped portion bites into the conductor core wire. Further, the projecting portion of the tubular inner face of the crimped portion is strongly pressed against the conductor core wire. Accordingly, the contact area and the contact pressure between the crimped portion and the conductor core wire increase as compared with a case without a projecting portion on the tubular inner face of the crimped portion. This increases the reliability of the electrical connection between the crimped portion and the conductor core wire. Therefore, according to the electrical wire with terminal of the present configuration, it is possible to improve the reliability of the electrical connection between the terminal and the electrical wire.

According to the thirteenth aspect of the present disclosure, in the electrical wire with terminal (1) according to the above twelfth aspect, the tubular inner face (25) of the crimped portion (22) has, at the cross section, two or more projecting portions (27) on the tubular inner face (25) of the crimped portion (22).

According to the electrical wire with terminal having the configuration of the above thirteenth aspect, the tubular inner face is provided with two or more projecting portions, so that the effect of enhancing the reliability of the electrical connection by the projecting portion described above is further improved.

According to the fourteenth aspect of the present disclosure, in the electrical wire with terminal (1) according to the above twelfth aspect, the crimped portion (22) includes a first part (22A) and a second part (22B) that are aligned in a direction of the axis. A position of the projecting portion (27) in the tubular inner face (25) of the first part (22A) and a position of the projecting portion (27) in the tubular inner face (25) of the second part (22B) are different in a direction around the axis.

According to the electrical wire with terminal having the configuration of the above fourteenth aspect, the projecting portion of the first part and the projecting portion of the second part bite into the conductor core wire from different positions in the direction around the axis. This increases the contact area and contact pressure between the crimped portion and the conductor core wire evenly in the direction around the axis, thereby further increasing the reliability of the electrical connection between the crimped portion and the conductor core wire.

According to the fifteenth aspect of the present disclosure, in the electrical wire with terminal (1) according to any one of the above twelfth to fourteenth aspects, the crimped portion (22) includes a recess (28) formed by recessing a tubular outer face of the crimped portion (22) into the tubular portion.

According to the electrical wire with terminal having the configuration of the above fifteenth aspect, the crimped portion is recessed into the tubular portion, so that the crimped portion is crimped to the conductor core wire in a shape in which the projecting portion of the tubular inner face bites more deeply into the conductor core wire of the electrical wire, and the projecting portion of the tubular inner face is more strongly pressed against the conductor core wire. Thus, according to the electrical wire with terminal of the present configuration, it is possible to further enhance the reliability of the electrical connection between the terminal and the electrical wire.

What is claimed is:

1. A method for manufacturing an electrical wire with terminal in which a terminal is crimped to a conductor core wire of an electrical wire, wherein
the terminal includes a connected portion to be connected to a mating terminal and a crimped portion to be crimped to the conductor core wire,
the crimped portion has a tubular shape continuous without a slit in a circumferential direction, and has a shape before crimping in which a tubular inner face of the crimped portion includes a projecting portion protruding into a tubular portion at a cross section orthogonal to an axis of the terminal, and
the manufacturing method comprises:
inserting the conductor core wire into the tubular portion of the crimped portion; and
crimping the crimped portion to the conductor core wire by caulking the crimped portion using a caulking tool, the caulking tool being configured to deform the crimped portion into the tubular portion by pressing a caulking face against the crimped portion.

2. The manufacturing method according to claim 1, wherein
the tubular inner face of the crimped portion has, at the cross section:
a shape in which a plurality of circular shapes are combined while partially overlapping each other,
a shape in which a plurality of elliptical shapes are combined while partially overlapping each other, or
a shape in which one or a plurality of circular shapes and one or a plurality of elliptical shapes are combined while partially overlapping each other.

3. The manufacturing method according to claim 1, wherein
the crimped portion includes a first part and a second part that are aligned in a direction of the axis,
the first part has a shape in which a cross-sectional area at the cross section of the tubular inner space decreases as approaching the second part, and
the second part has a shape in which a cross-sectional area at the cross section of the tubular inner space decreases as approaching the first part.

4. The manufacturing method according to claim 3, wherein
the tubular inner space of the first part and the tubular inner space of the second part are adjacent and communicate with each other, or the tubular inner space of the first part and the tubular inner space of the second part communicate with each other via another tubular inner space.

5. The manufacturing method according to claim 3, wherein
a position of the projecting portion in the tubular inner face of the first part and a position of the projecting portion in the tubular inner face of the second part are different in a direction around the axis.

6. The manufacturing method according to claim 1, wherein
the caulking tool has a protruding portion on the caulking face to recess the crimped portion into the tubular portion of the crimped portion.

7. A terminal to be crimped to a conductor core wire of an electrical wire, the terminal comprising:
a connected portion to be connected to a mating terminal; and
a crimped portion to be crimped to the conductor core wire, wherein
the crimped portion has a tubular shape continuous without a slit in a circumferential direction, and has a shape before crimping in which a tubular inner face of the crimped portion includes a projecting portion protruding into the tubular portion at a cross section orthogonal to an axis of the terminal.

8. The terminal according to claim 7, wherein
the tubular inner face of the crimped portion has, at the cross section:
a shape in which a plurality of circular shapes are combined while partially overlapping each other,
a shape in which a plurality of elliptical shapes are combined while partially overlapping each other, or
a shape in which one or a plurality of circular shapes and one or a plurality of elliptical shapes are combined while partially overlapping each other.

9. The terminal according to claim 7, wherein
the crimped portion includes a first part and a second part that are aligned in a direction of the axis,
the first part has a shape in which a cross-sectional area at the cross section of the tubular inner space decreases as approaching the second part, and
the second part has a shape in which a cross-sectional area at the cross section of the tubular inner space decreases as approaching the first part.

10. The terminal according to claim 9, wherein
the tubular inner space of the first part and the tubular inner space of the second part are adjacent and communicate with each other, or the tubular inner space of the first part and the tubular inner space of the second part communicate with each other via another tubular inner space.

11. The terminal according to claim 9, wherein
a position of the projecting portion in the tubular inner face of the first part and a position of the projecting portion in the tubular inner face of the second part are different in a direction around the axis.

12. An electrical wire with terminal comprising:
an electrical wire; and
a terminal crimped to a conductor core wire of the electrical wire, wherein
the terminal includes:
a connected portion to be connected to a mating terminal; and
a crimped portion crimped to the conductor core wire,
the crimped portion has a tubular shape continuous without a slit in a circumferential direction, and has a shape in which a tubular inner face of the crimped portion has a plurality of curved faces convex out of a tubular portion at a cross section orthogonal to an axis of the terminal, and
at the cross section, a location where one of the curved faces and another of the curved faces are coupled defines a projecting portion protruding into the tubular portion of the crimped portion.

13. The electrical wire with terminal according to claim 12, wherein
at the cross section, the tubular inner face of the crimped portion has two or more projecting portions on the tubular inner face of the crimped portion.

14. The electrical wire with terminal according to claim 12, wherein
the crimped portion includes a first part and a second part that are aligned in a direction of the axis, and
a position of the projecting portion in the tubular inner face of the first part and a position of the projecting portion in the tubular inner face of the second part are different in a direction around the axis.

15. The electrical wire with terminal according to claim 12, wherein
the crimped portion includes a recess formed by recessing a tubular outer face of the crimped portion into the tubular portion.
